(19) United States
(12) Patent Application Publication
(10) Pub. No.: US 2019/0077652 A1
(43) Pub. Date: Mar. 14, 2019

(54) VALVE FOR VAPOUR RECOVERY SYSTEM

(71) Applicant: FORT VALE ENGINEERING LIMITED, Burnley Lancashire (GB)

(72) Inventors: David BAILEY, Burnley Lancashire (GB); John HIRD, Foulridge Lancashire (GB)

(21) Appl. No.: 16/084,216

(22) PCT Filed: Mar. 13, 2017
(86) PCT No.: PCT/GB2017/050680

§ 371 Date: Sep. 11, 2018

(30) Foreign Application Priority Data
Mar. 11, 2016 (GB) 1604245.9

(51) Int. Cl. B67D 7/04; B67D 7/54; F16L 37/44

(52) U.S. Cl. CPC B67D 7/048; F16L 37/44; B67D 7/54

(57) ABSTRACT

A valve for a vapour recovery system including a valve body having an inlet and an outlet, a valve seat within the valve body, a valve closure member releasably engageable with the valve seat, a socket portion for receiving a pipe member, a plurality of engagement members configured to be releasably engageable with a portion of a pipe member received in the socket portion for releasably retaining the pipe member in the socket portion, and an actuation member mounted on the valve body. The actuation member includes a recess for receiving each of the engagement members and is displaceable between a first position in which the engagement members are received in the recesses in the actuation member, and a second position in which the actuation member urges the engagement members inwardly towards a deployed configuration in which they engage with and retain a pipe member located in the socket portion.

The present invention relates to valves for vapour recovery systems.

When a tanker is loaded with a volatile product, such as petrol (gasoline), it is necessary to connect the tanker to a venting system so that vapour in the tanker which is displaced by the product can be removed. The removed vapour can be reclaimed, which reduces waste and pollution and avoids the unwanted discharge of potentially harmful, e.g. flammable or toxic, vapours.

Typically, when a tanker is to be filled with volatile liquid, a venting pipe connected to a vent outlet on the tanker is connected to the valve of a vapour recovery system. The end of the vapour recovery pipe remote from the tanker is also provided with a valve and the coupling between the vapour recovery pipe and the vapour recovery valve is such that upon connection of the two, the valves within each portion are opened automatically, so that fluid vapour may pass through the vapour recovery valve to the vapour recovery system.

Similarly, when the vapour recovery pipe is disengaged from the vapour recovery valve, the valves in the two disconnected sections automatically close, thereby minimising leakage of vapour.

One common arrangement comprises a plurality of camlock fittings on the vapour recovery valve which are engageable manually with a peripheral groove in the end of the vapour recovery pipe. The problem with this system is that the cams cause heavy wear on the groove, with the result that the cams and/or the end of the vapour recovery pipe require frequent replacement.

It is an object of the present invention to provide a valve for a vapour recovery system which can be used with existing fittings but which overcomes or alleviates the problems associated with the prior art.

In accordance with the present invention, a valve for a vapour recovery system comprises a valve body having an inlet and an outlet, a valve seat located within the valve body, a valve closure member releasably engageable with the valve seat, a socket portion for receipt of a pipe member to be coupled, a plurality of engagement members configured to be releasably engageable with a portion of a pipe member received in the socket portion for releasably retaining the pipe member in the socket portion and an actuation member mounted on the valve body, the actuation member comprising a recess for receipt of each of the engagement members, the actuating member being displaceable between a first position in which the engagement members are received in the recess in the actuation member and a second position in which the actuation member urges the engagement members inwardly towards a deployed configuration in which they engage with and retain a pipe member located in the socket portion.

The above arrangement significantly reduces the wear on a vapour recovery pipe secured within the socket, since the vapour recovery pipe can be engaged at a larger number of locations as compared with the prior art arrangements.

Preferably, the engagement members are mounted on the valve body.

The engagement members may be mounted in a recess in the valve body, preferably a through recess in the valve body.

In one embodiment, the engagement members comprise balls.

In another embodiment, the engagement members comprise rollers.

Preferably, the valve further comprises biasing means means for biasing the actuating member towards its second position, for example spring means for biasing the actuation member towards its second position.

The valve further preferably comprises locking means for preventing movement of the actuating member from its first position to its second position until a pipe member is engaged in the socket portion.

The valve may comprise a locking member mounted in a through recess in the valve body and being receivable in a recess in the actuation member, the locking member being displaceable between a first, locking position in which it is received in the recess in the actuation member and a second, unlocked position in which it is displaced out of the recess in the actuation member.

The valve may further comprise spring means for biasing the locking member towards the second, unlocked position.

In certain embodiments, the valve comprises an engagement member slidably disposed within the valve body, the engagement member being displaceable by engagement of a pipe member in the socket portion between a first position in which it abuts the locking member and retains it in its first, locking position and a second position in which it is displaced out of engagement with the locking member.

Preferably, the locking member is displaced radially inwardly into its second, unlocked position.

Preferably, the locking member is displaced radially inwardly into a recess in the pipe member engaged in the socket portion.

In one embodiment, the engagement member comprises an elongate recess in which the locking member is located and which allows movement of the engagement member with the locking member in its first, locking position, the elongate recess having an enlarged portion for receipt of the locking member, to permit the locking member to be displaced to its second, unlocked position.

The enlarged portion for receipt of the locking member is preferably located at one end of the elongate recess.

The engagement member may be connected to the valve closure member, wherein the position of the engagement member determines the position of the valve closure member.

The valve may comprise a connecting link extending between the engagement member and the valve closure member.

The locking means locking means may comprise latch means mounted on the valve body, the latch means being displaceable between a first, latched position in which it retains the actuation member in its first position and a second, unlatched position in which it is disengaged from the actuation member.

The latch means are preferably mounted in the socket portion and configured to be displaced to the second, unlatched position on receipt of a pipe member in the socket portion.

Preferably, the valve further comprises release means for disengaging the engagement member from a pipe located in the socket.

The release means may comprise a handle for displacing the actuation member from its second position towards its first position.

Preferably, the handle is pivotally mounted with respect to the valve body.

The handle may be displaceable manually.

In an alternative arrangement, the valve closure member is operable manually by displacement of a valve actuating handle and the position of the valve actuating handle determines the position of the release handle.

The valve may comprise cam means movable with the valve actuating handle and connected to the release handle.

By way of example only, specific embodiments of the present invention will now be described with reference to the accompanying drawings, in which:

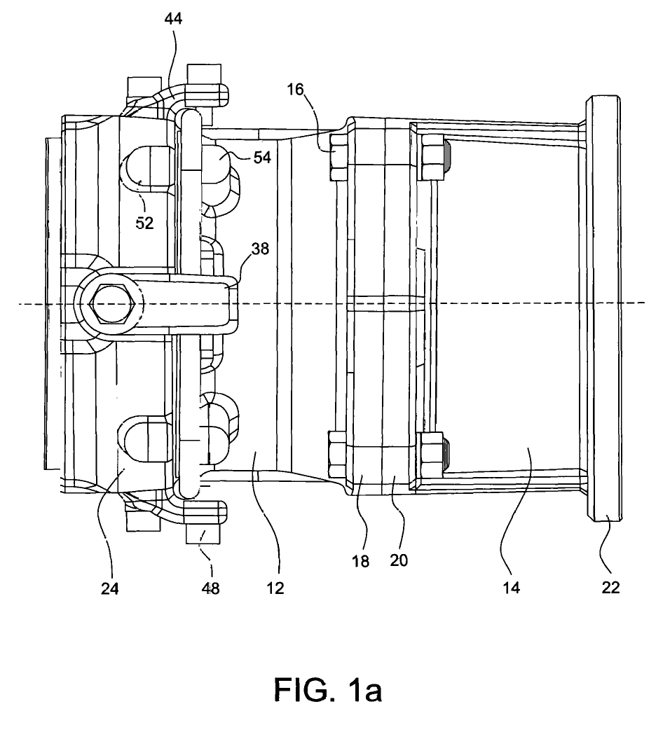

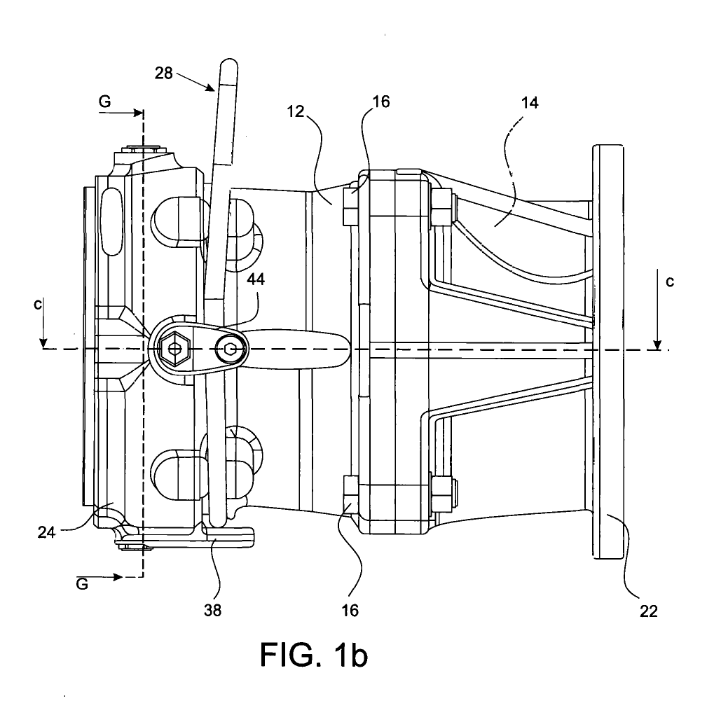

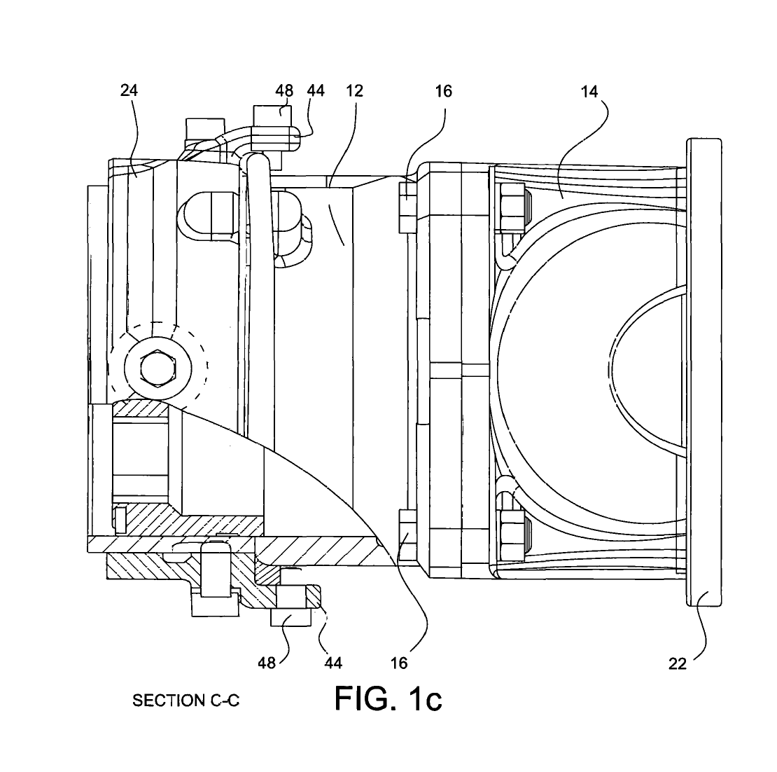

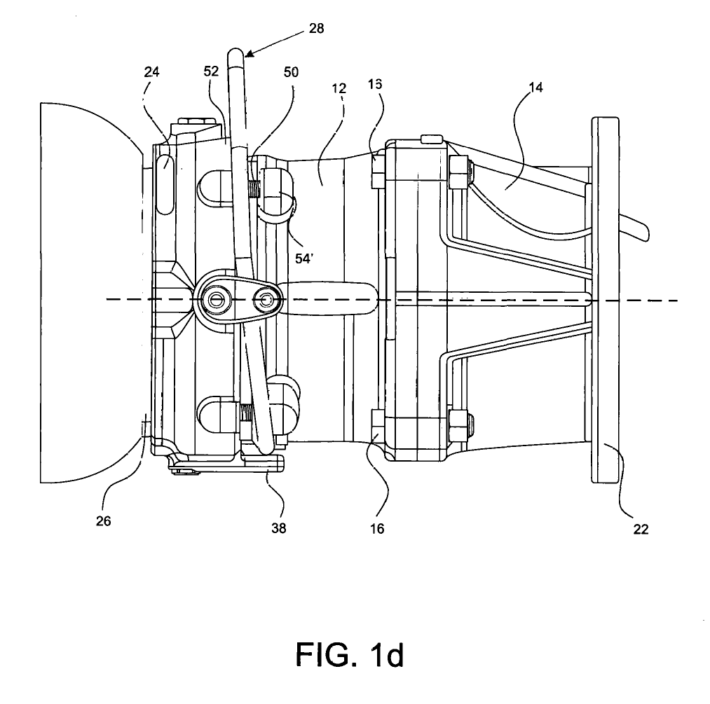

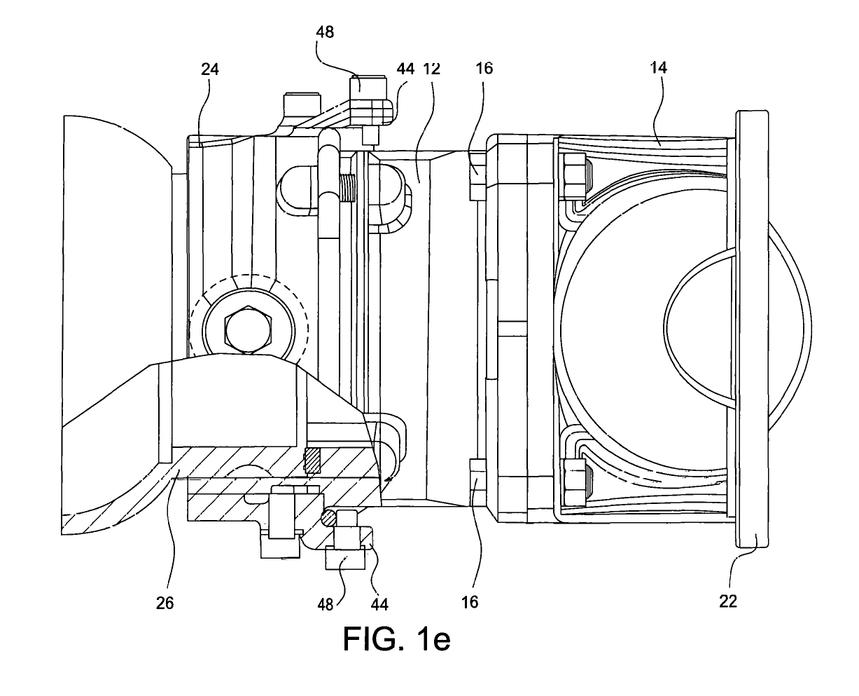

FIGS. 1(a) to (e) are various views of a first embodiment of vapour recovery valve in accordance with the present invention, namely:

(a) an inverted plan view of the valve in an uncoupled condition;

(b) a side view of the valve in an uncoupled condition;

(c) a plan view of the valve in an uncoupled condition, shown partly cut away;

(d) a side view of the valve in a coupled condition;

(e) a plan view of the valve in a coupled condition;

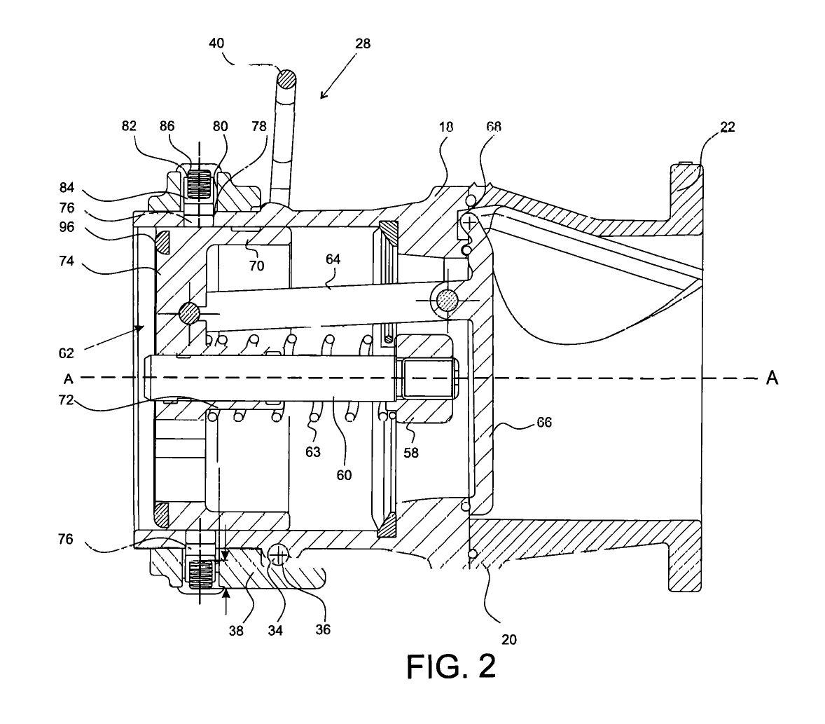

FIG. 2 is a longitudinal cross-section of the vapour recovery valve of FIG. 1, shown in an uncoupled condition;

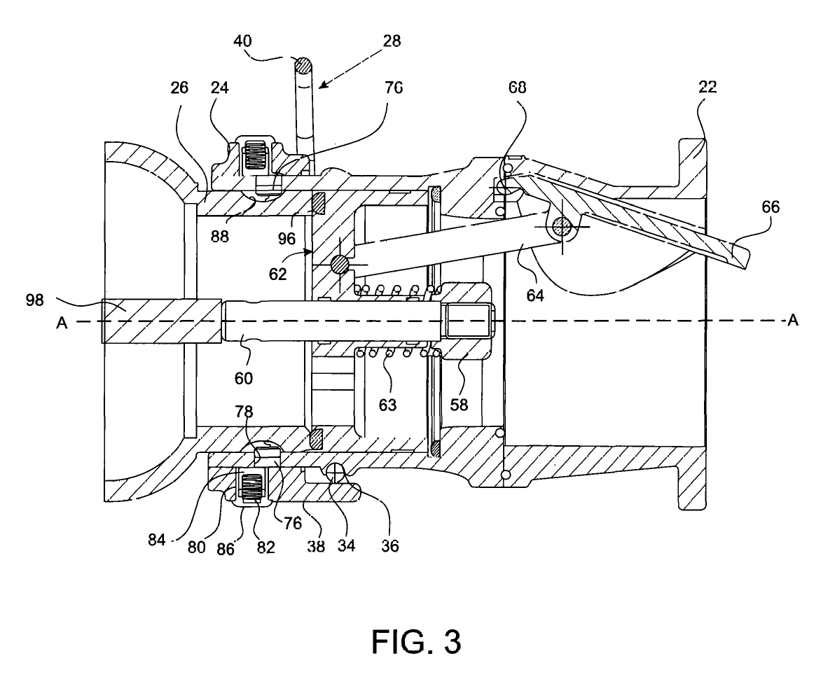

FIG. 3 is a longitudinal cross-section of the vapour recovery valve of FIG. 1, shown in a coupled condition;

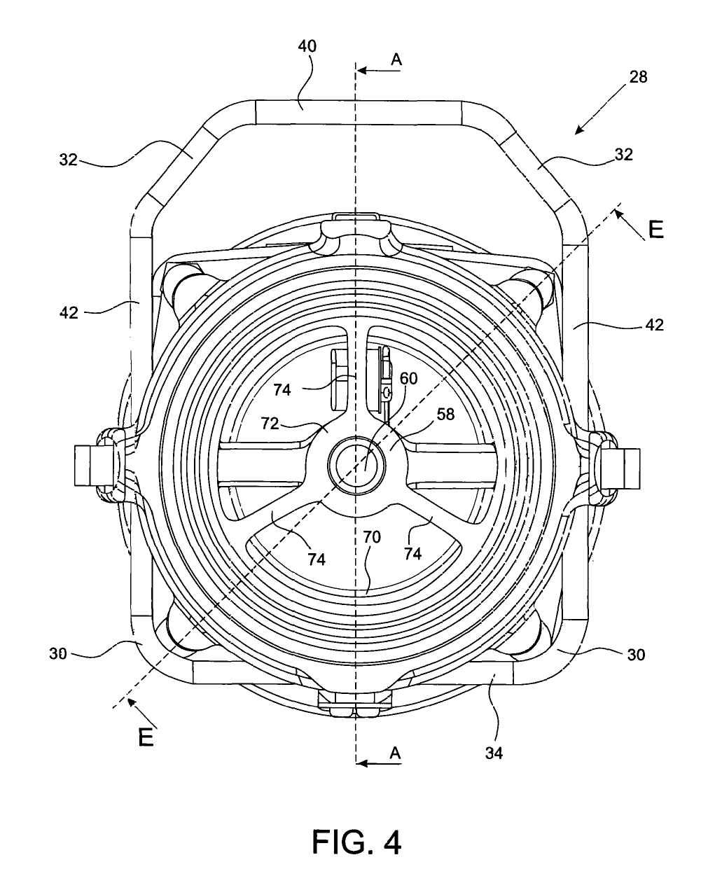

FIG. 4 is a front view of the vapour recovery valve of FIG. 1, shown in an uncoupled condition;

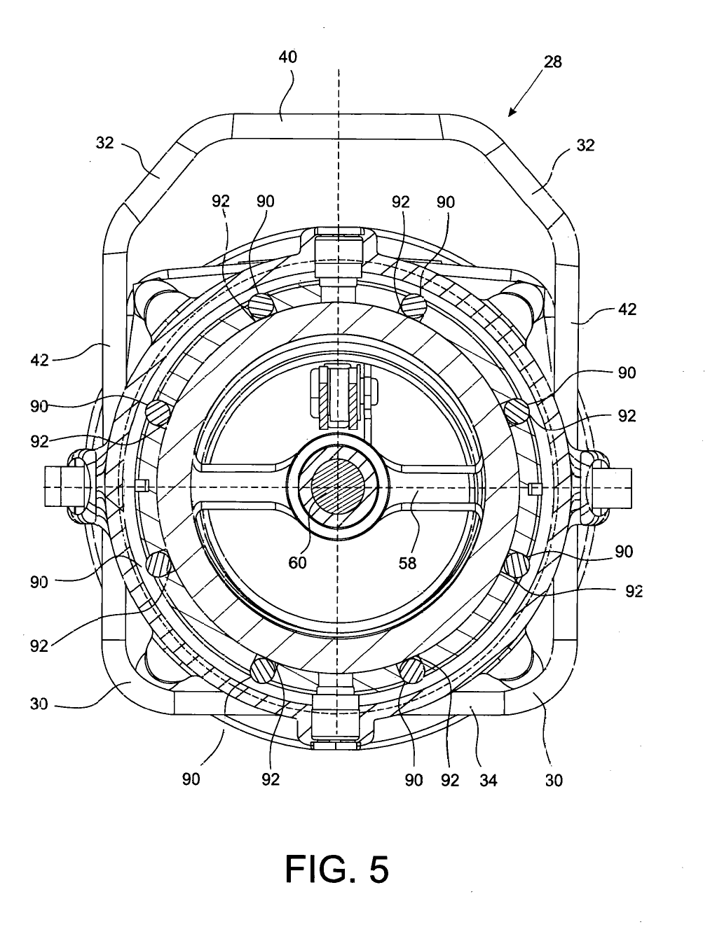

FIG. 5 is a vertical cross-section of the vapour recovery valve of FIG. 1 looking in the direction of arrows G-G of FIG. 1(b), shown in an uncoupled condition;

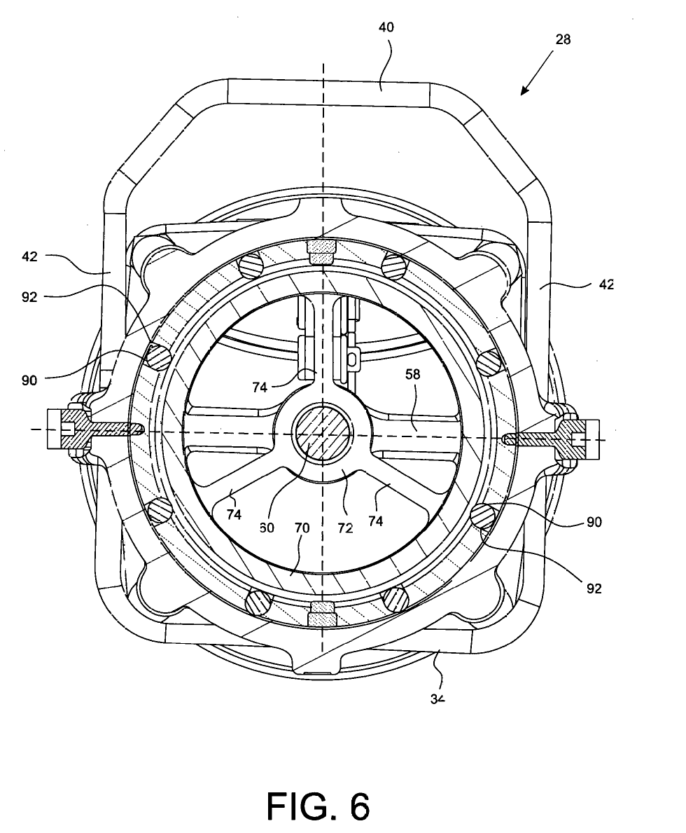

FIG. 6 is a vertical cross-section of the vapour recovery valve of FIG. 1 looking in the direction of arrows G-G of FIG. 1(b), shown in a coupled condition;

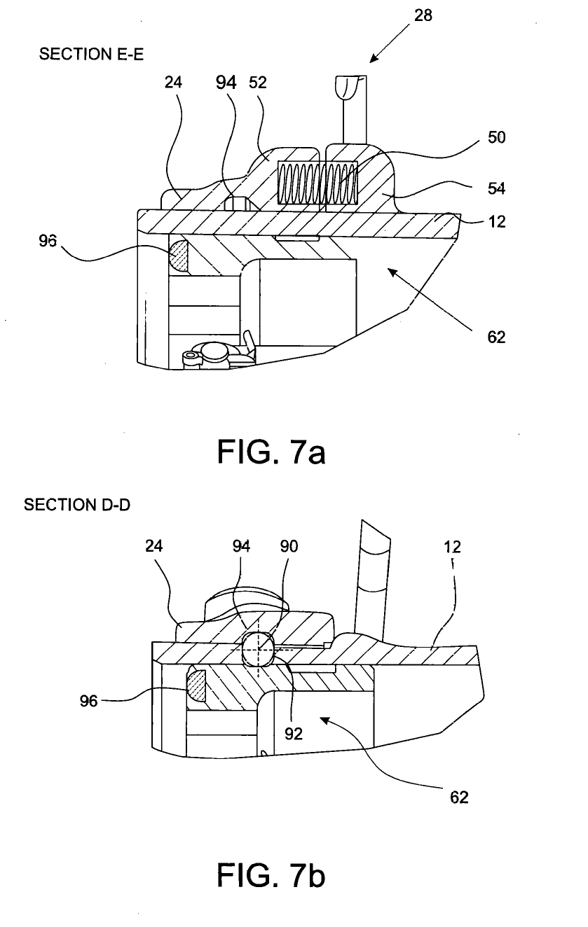

FIGS. 7 (a) and (b) are detailed vertical cross-sections through a securing collar portion of the vapour recovery valve of FIG. 1, shown in an uncoupled condition;

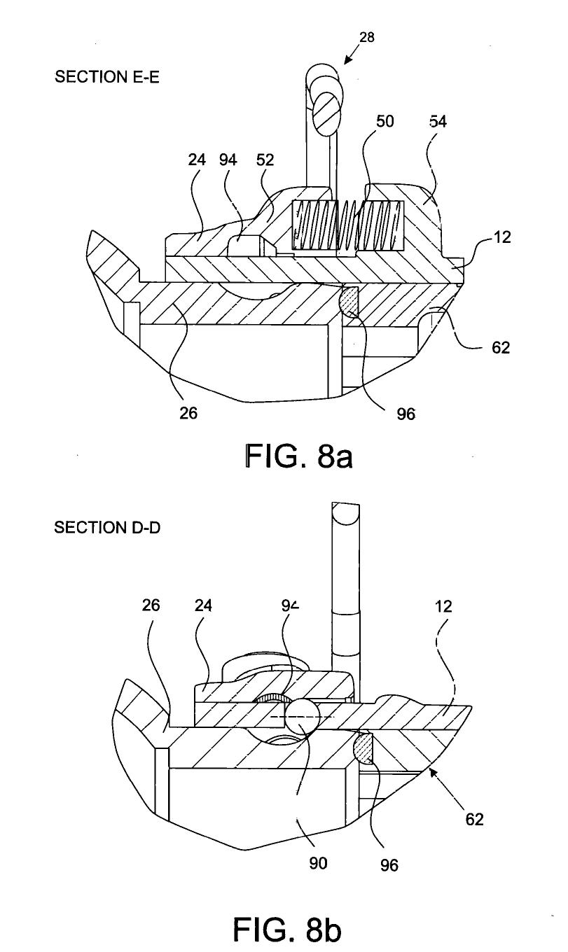

FIGS. 8 (a) and (b) are detailed vertical cross-sections through a securing collar portion of the vapour recovery valve of FIG. 1, shown in a coupled condition;

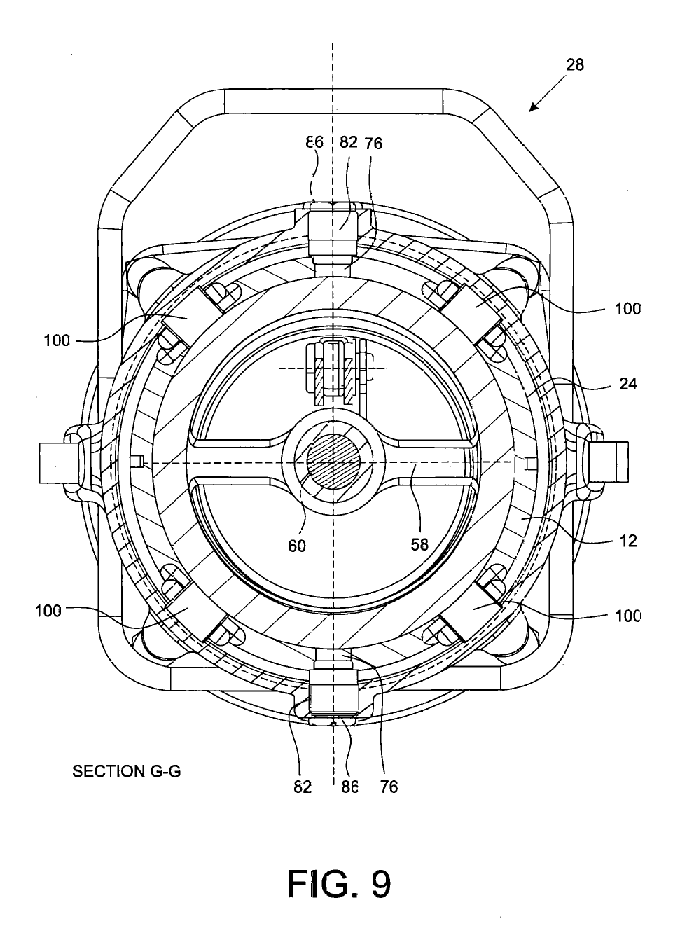

FIG. 9 is a vertical cross-section, looking forwardly, through a second embodiment of vapour recovery valve in accordance with the present invention, shown in an uncoupled condition;

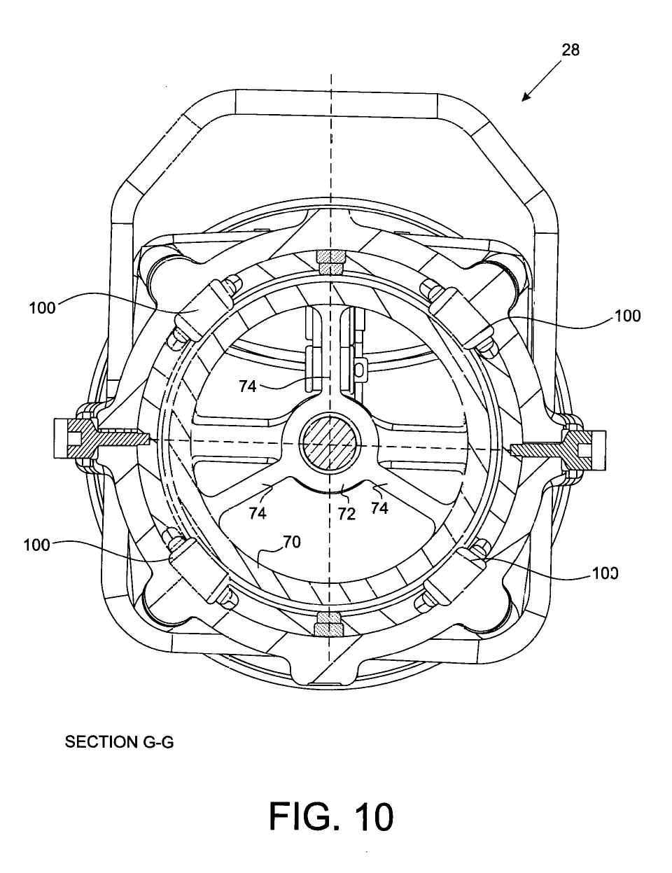

FIG. 10 is a vertical cross-section, looking rearwardly, through the vapour recovery valve of FIG. 9, shown in an uncoupled condition;

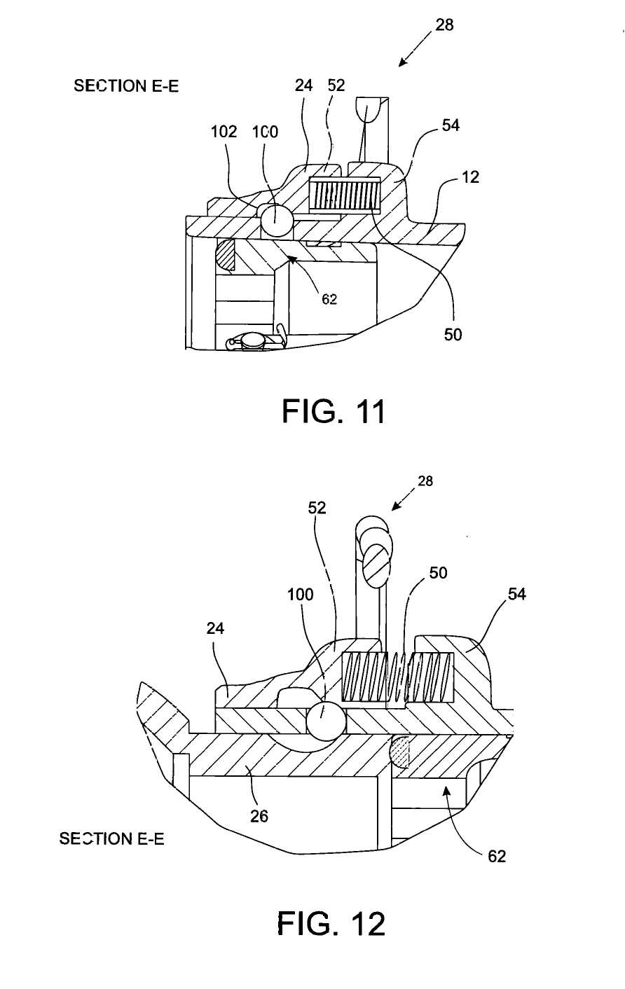

FIG. 11 is a detailed vertical cross-section through a securing collar portion of the vapour recovery valve of FIG. 9, shown in an uncoupled condition;

FIG. 12 is a detailed vertical cross-section through a securing collar portion of the vapour recovery valve of FIG. 9, shown in a coupled condition;

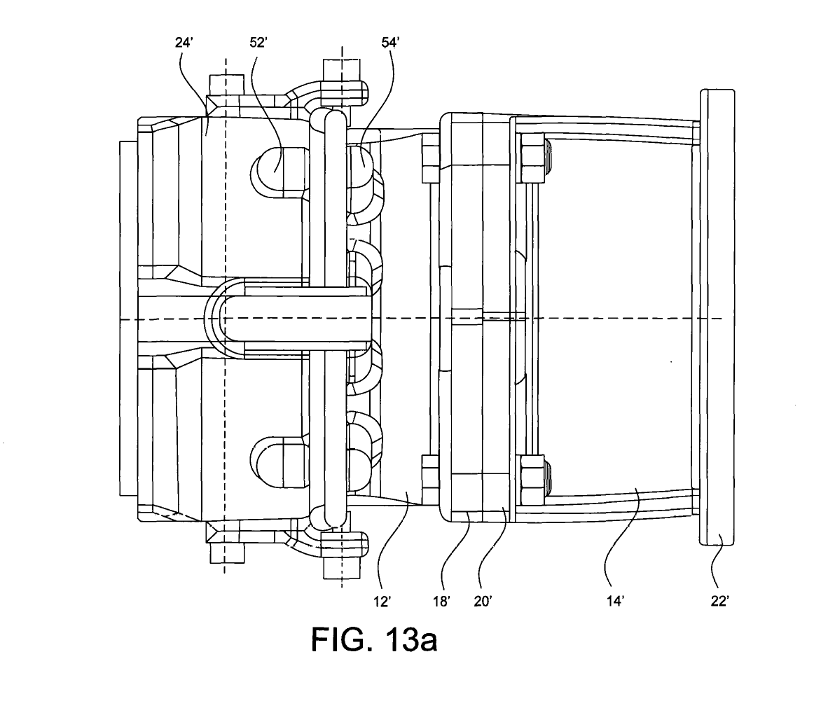

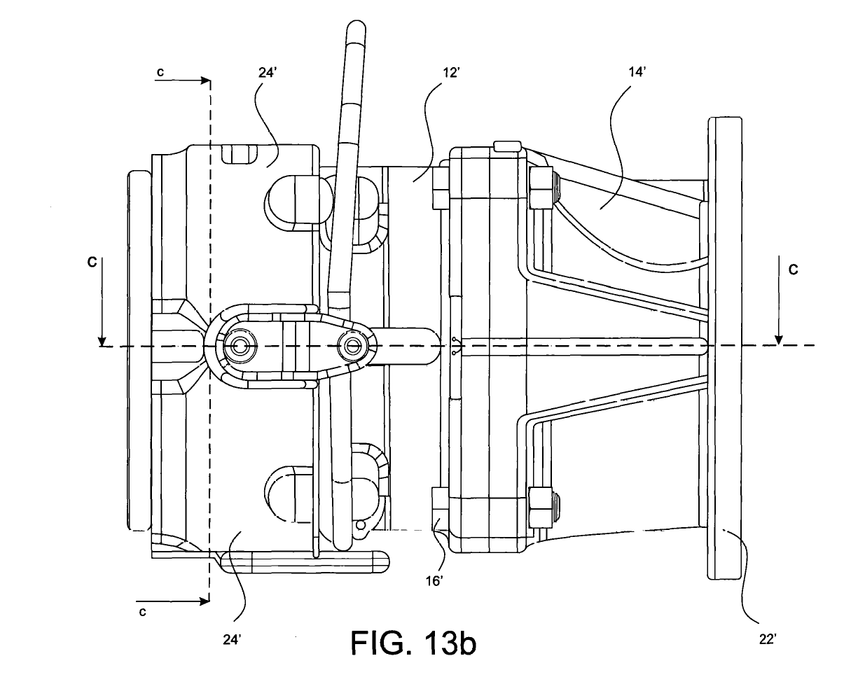

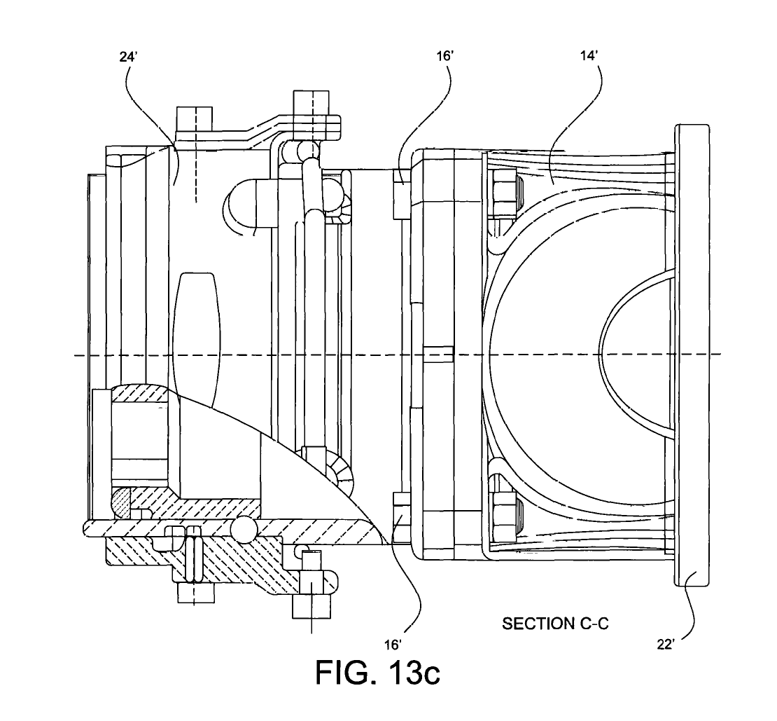

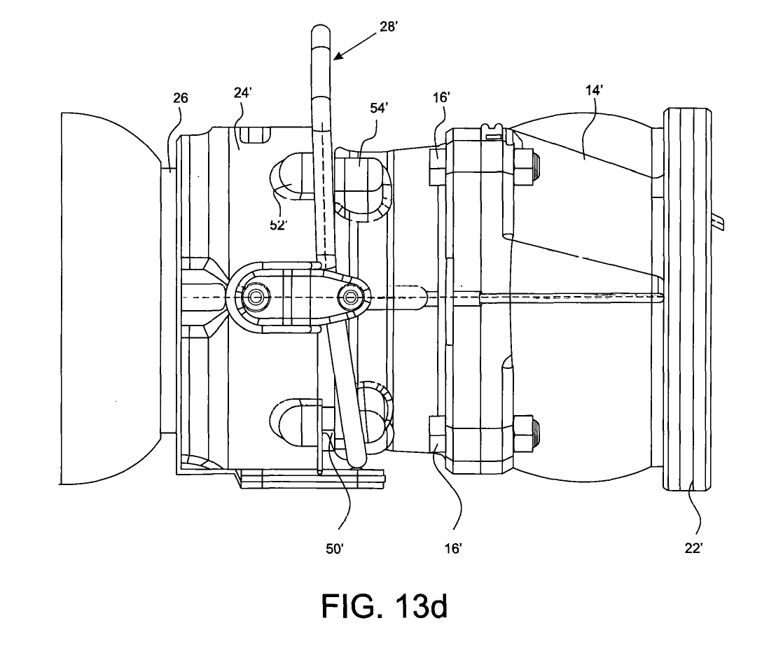

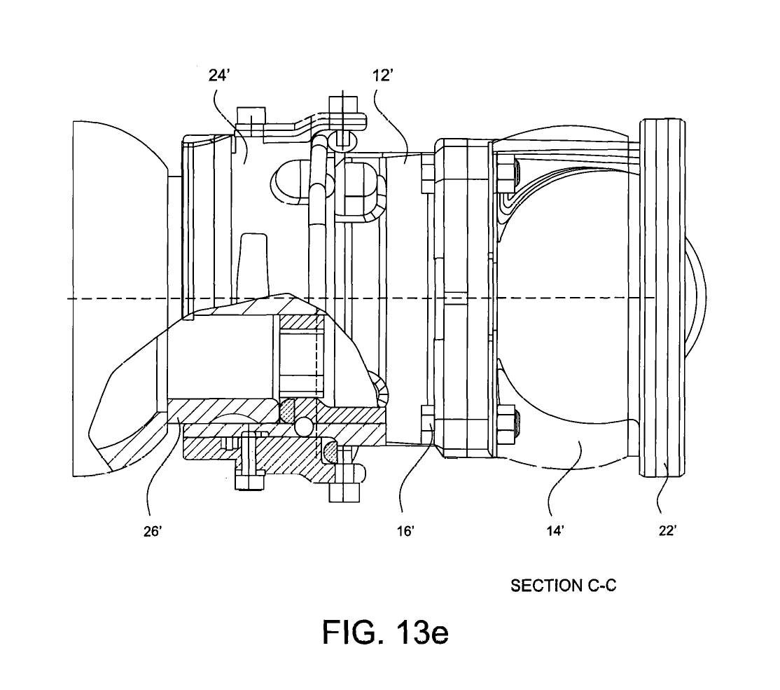

FIGS. 13 (a) to (e) are various views of a third embodiment of vapour recovery valve in accordance with the present invention, namely:

(a) an inverted plan view of the valve in an uncoupled condition;

(b) a side view of the valve in an uncoupled condition;

(c) a plan view of the valve in an uncoupled condition, shown partly cut away;

(d) a side view of the valve in a coupled condition;

(e) a plan view of the valve in a coupled condition;

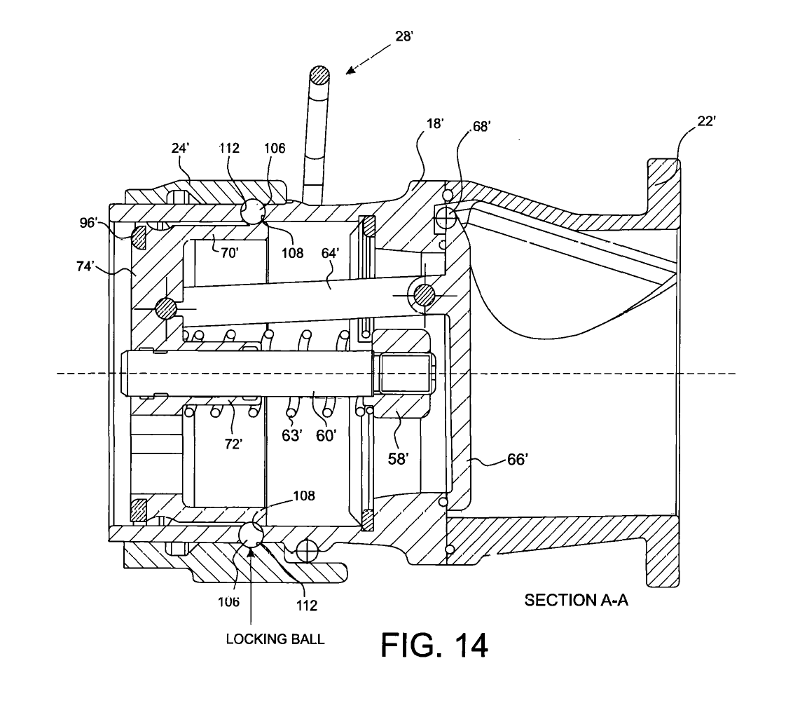

FIG. 14 is a longitudinal cross-section of the vapour recovery valve of FIG. 13, shown in an uncoupled condition;

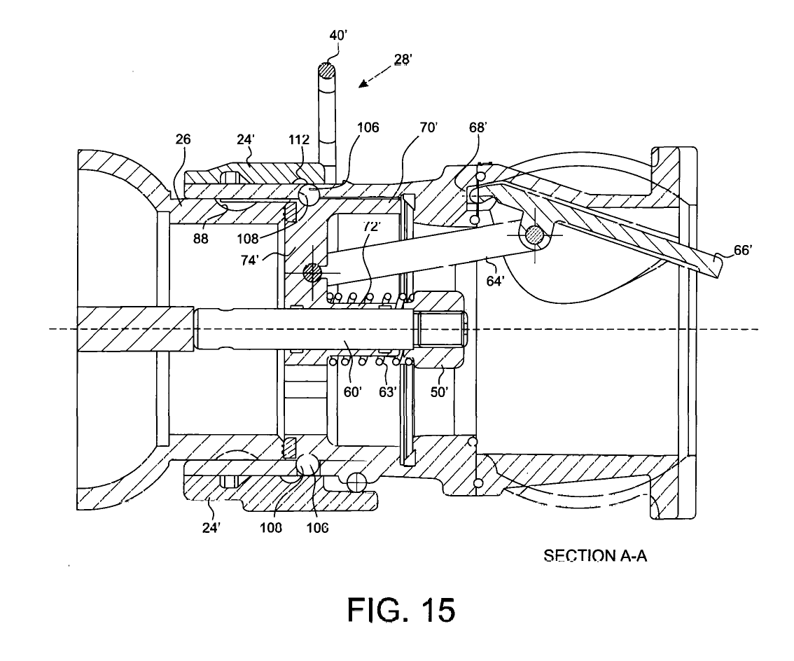

FIG. 15 is a longitudinal cross-section of the vapour recovery valve of FIG. 13, shown in a coupled condition;

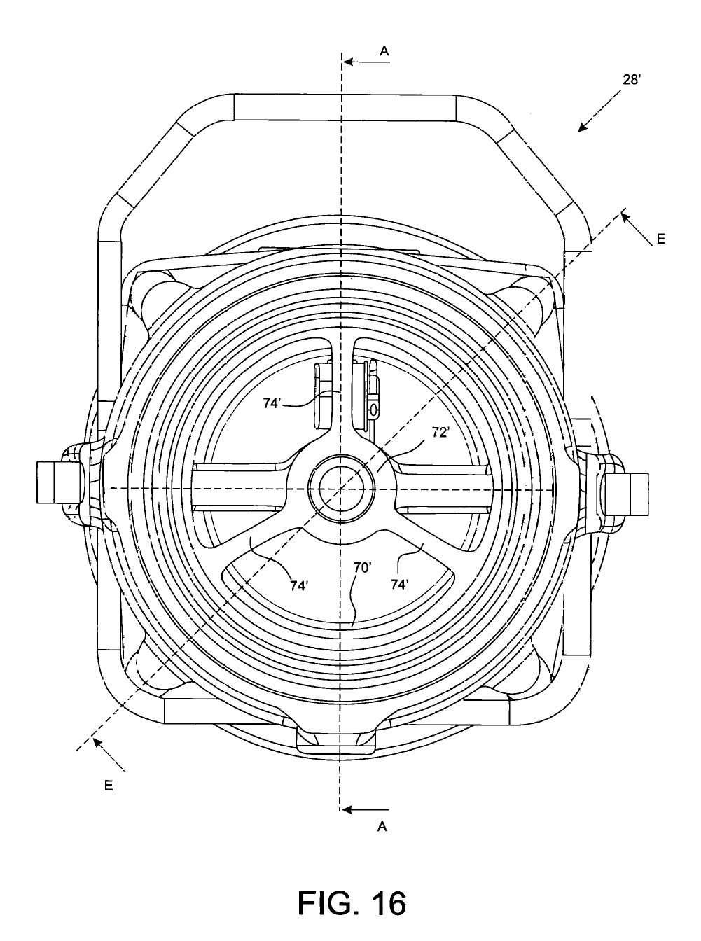

FIG. 16 is a front view of the vapour recovery valve of FIG. 13, shown in an uncoupled condition;

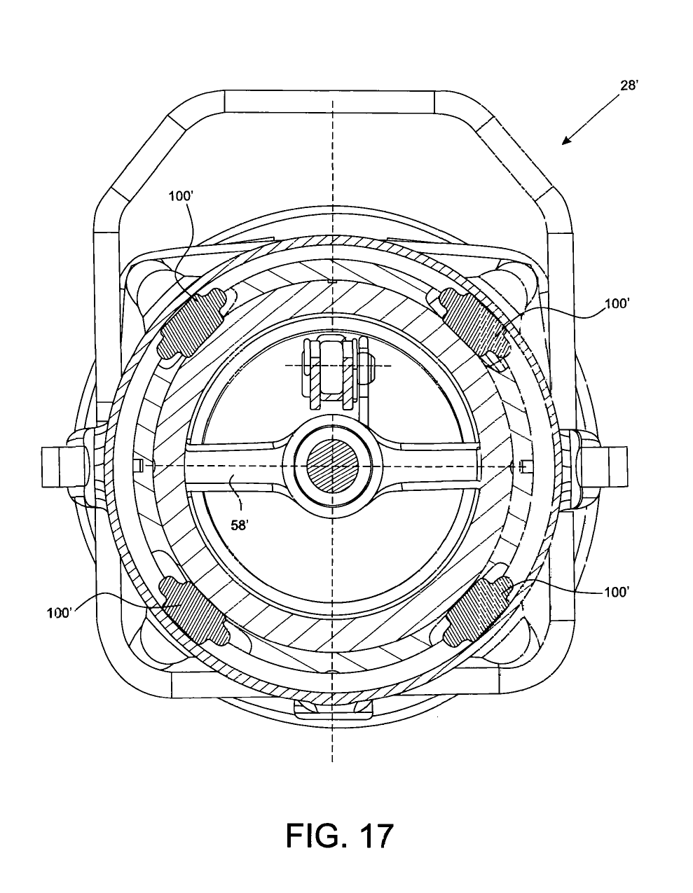

FIG. 17 is a vertical cross-section of the vapour recovery valve of FIG. 13, looking in the direction of arrows G-G of FIG. 13(b), shown in an uncoupled condition;

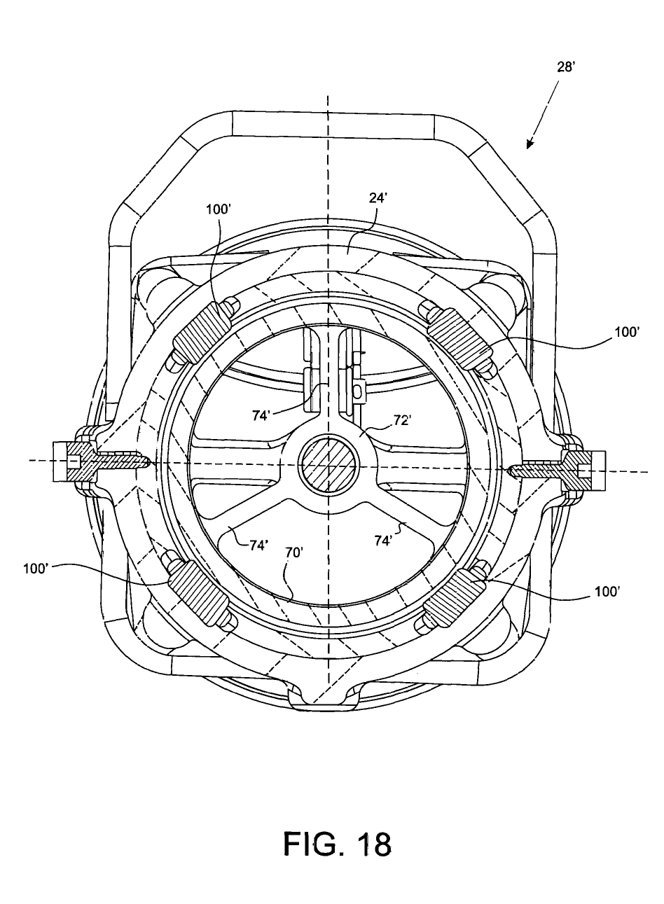

FIG. 18 is a vertical cross-section of the vapour recovery valve of FIG. 13, looking in the direction of arrows G-G of FIG. 13(b), shown in a coupled condition;

FIG. 19 is a perspective view of an actuating member forming part of the valve of FIG. 13;

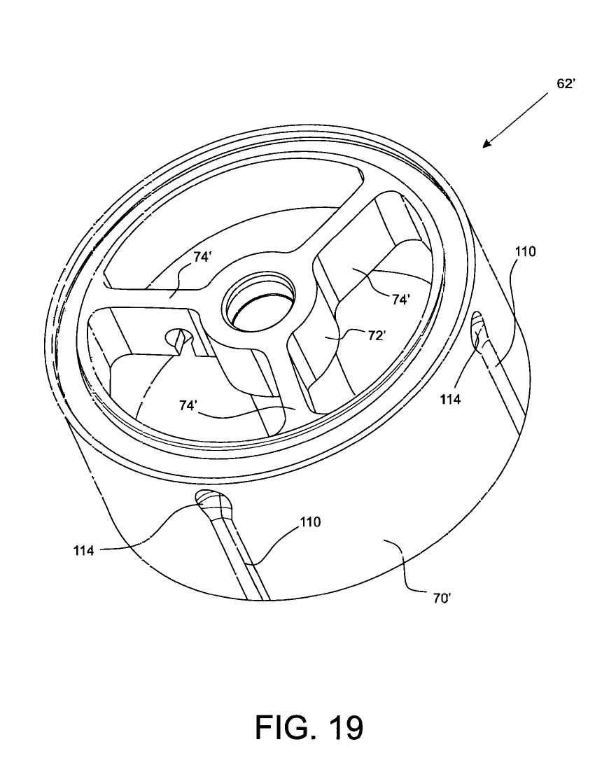

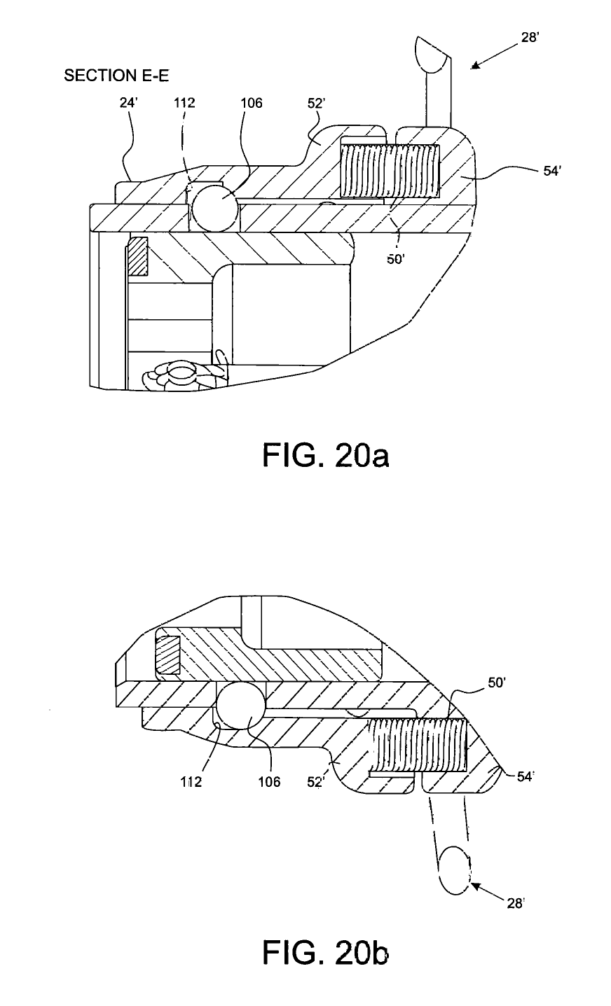

FIGS. 20 (a) and (b) are detailed vertical cross-sections through a securing collar portion of the vapour recovery valve of FIG. 13, shown in an uncoupled condition;

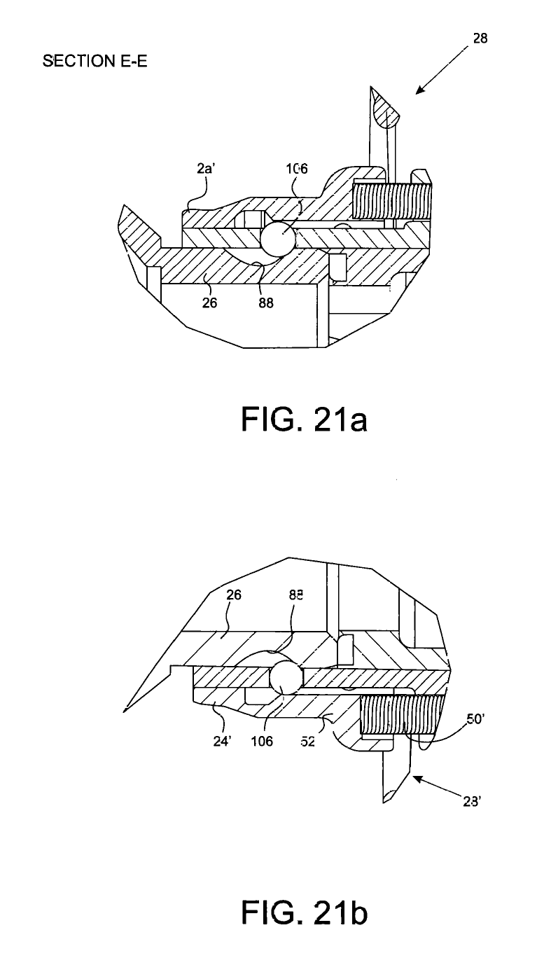

FIGS. 21 (a) and (b) are detailed vertical cross-sections through a securing collar portion of the vapour recovery valve of FIG. 13, shown in a coupled condition;

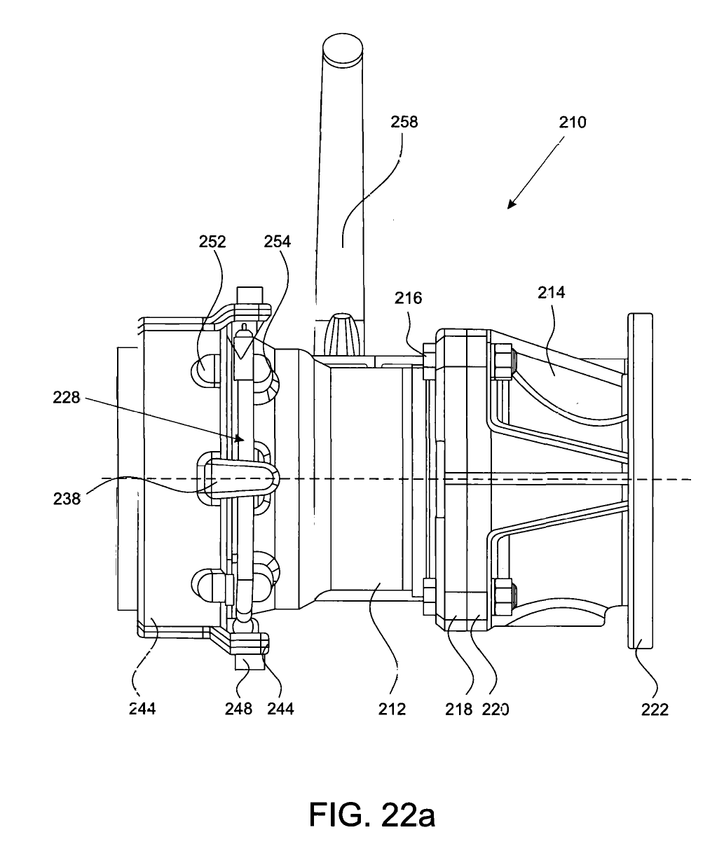

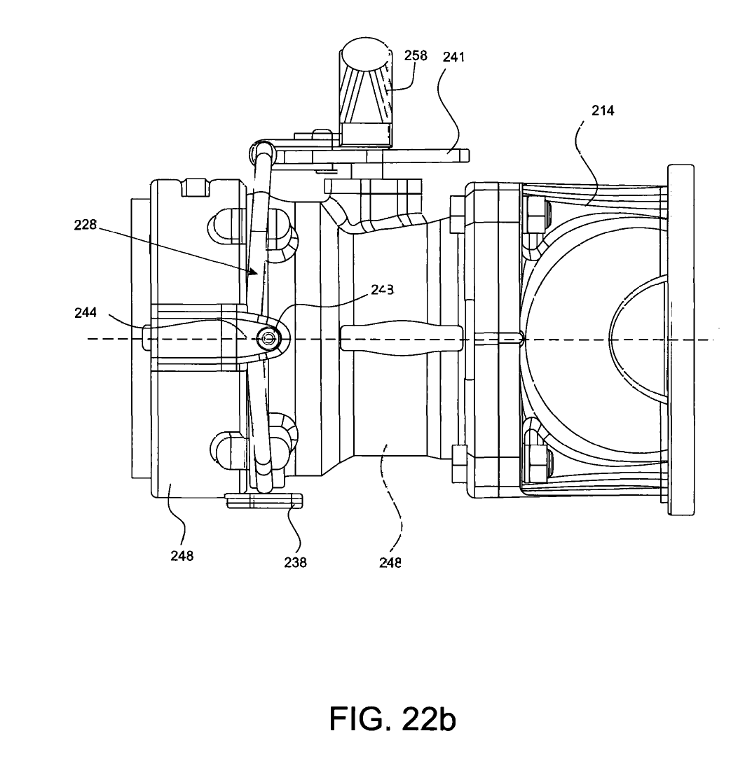

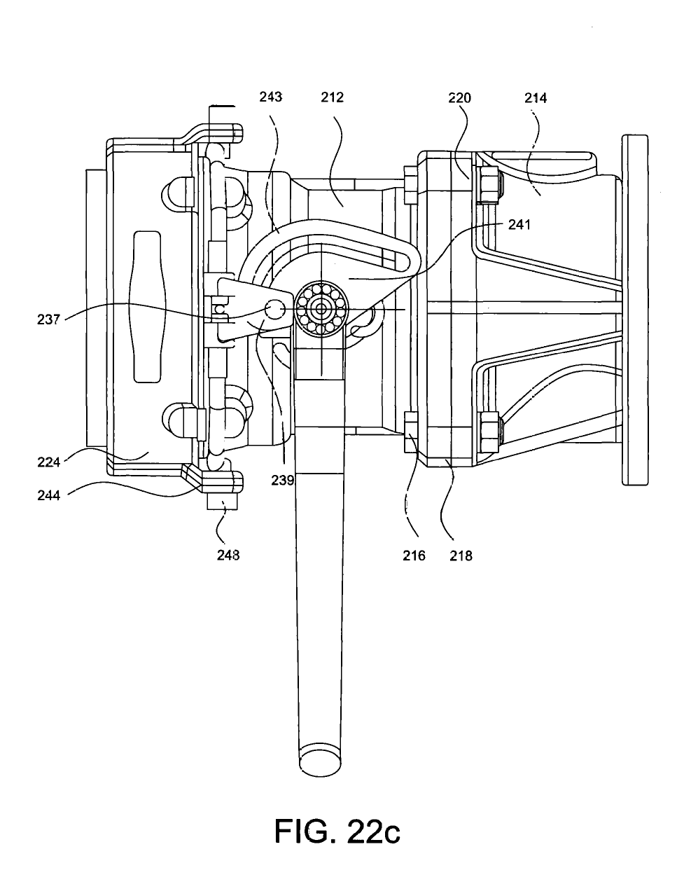

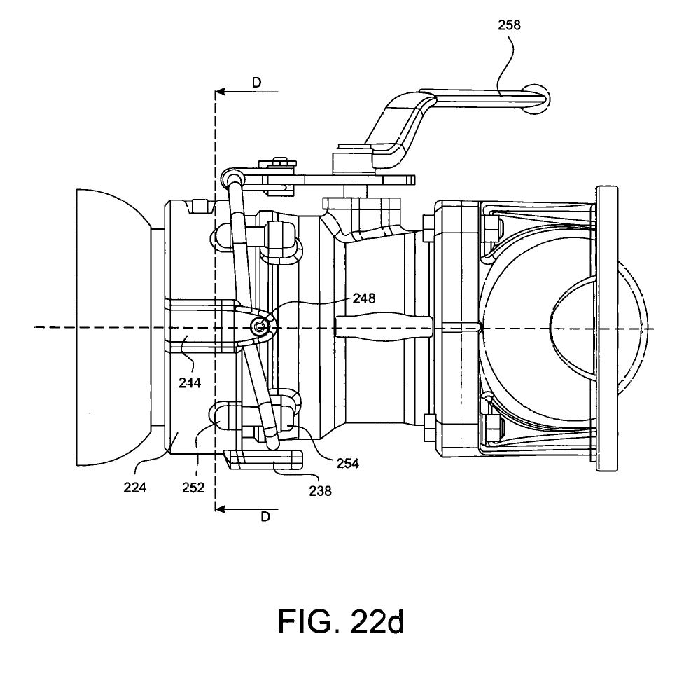

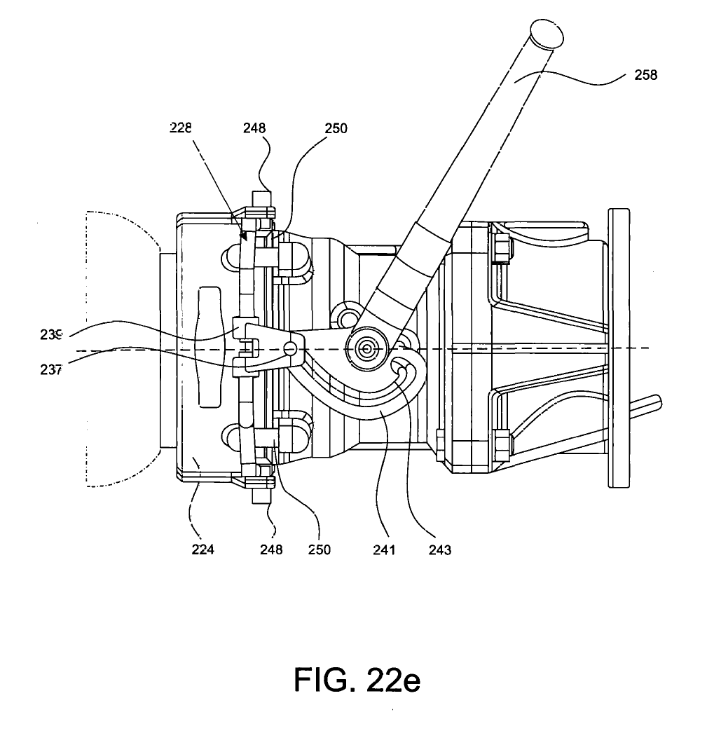

FIGS. 22 (a) to (e) are various views of a fourth embodiment of vapour recovery valve in accordance with the present invention, namely:

(a) an inverted plan view of the valve in an uncoupled condition;

(b) a side view of the valve in an uncoupled condition;

(c) a plan view of the valve in an uncoupled condition, shown partly cut away;

(d) a side view of the valve in a coupled condition;

(e) a plan view of the valve in a coupled condition;

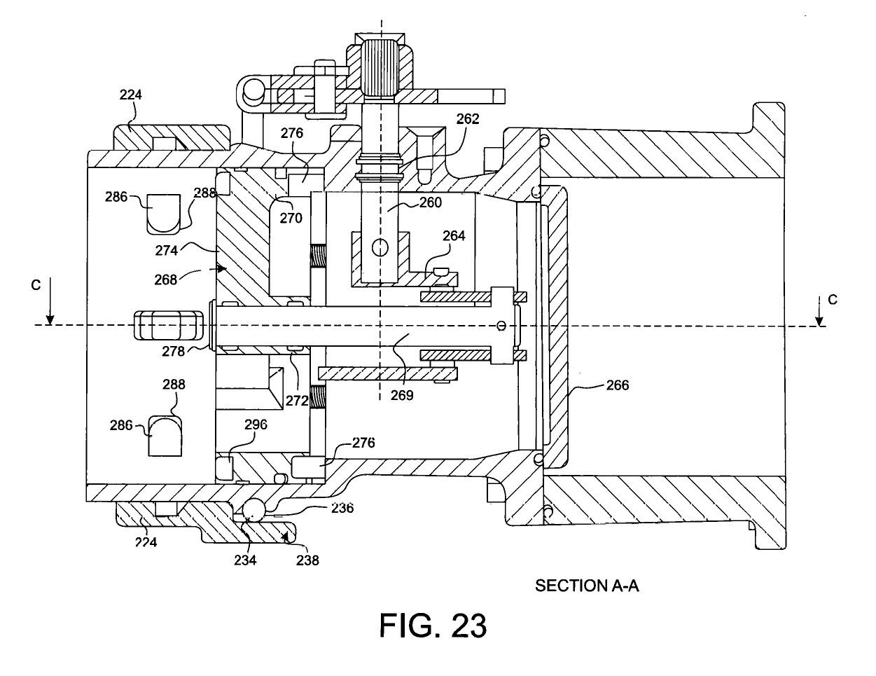

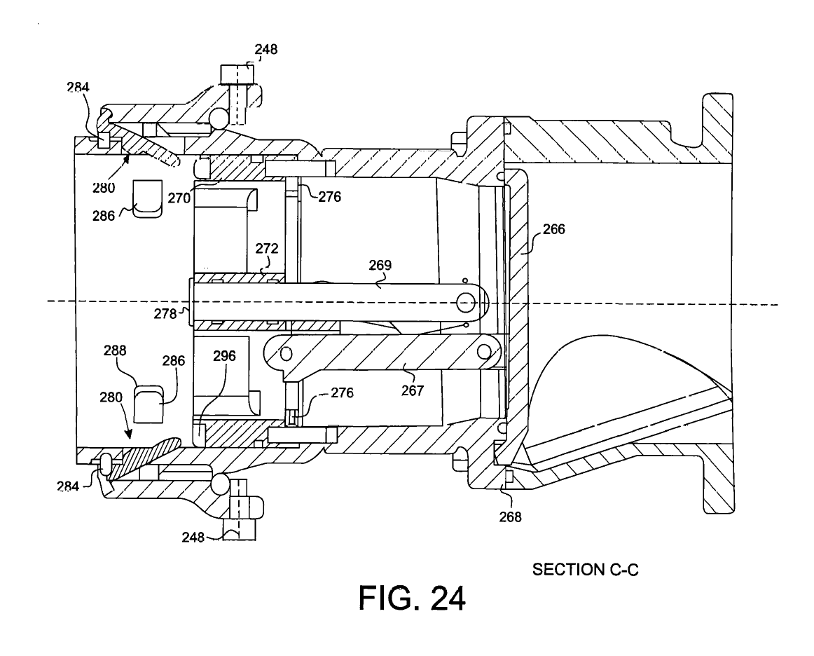

FIGS. 23 and 24 are longitudinal cross-sections, inclined at right angles, of the vapour recovery valve of FIG. 22, shown in an uncoupled condition;

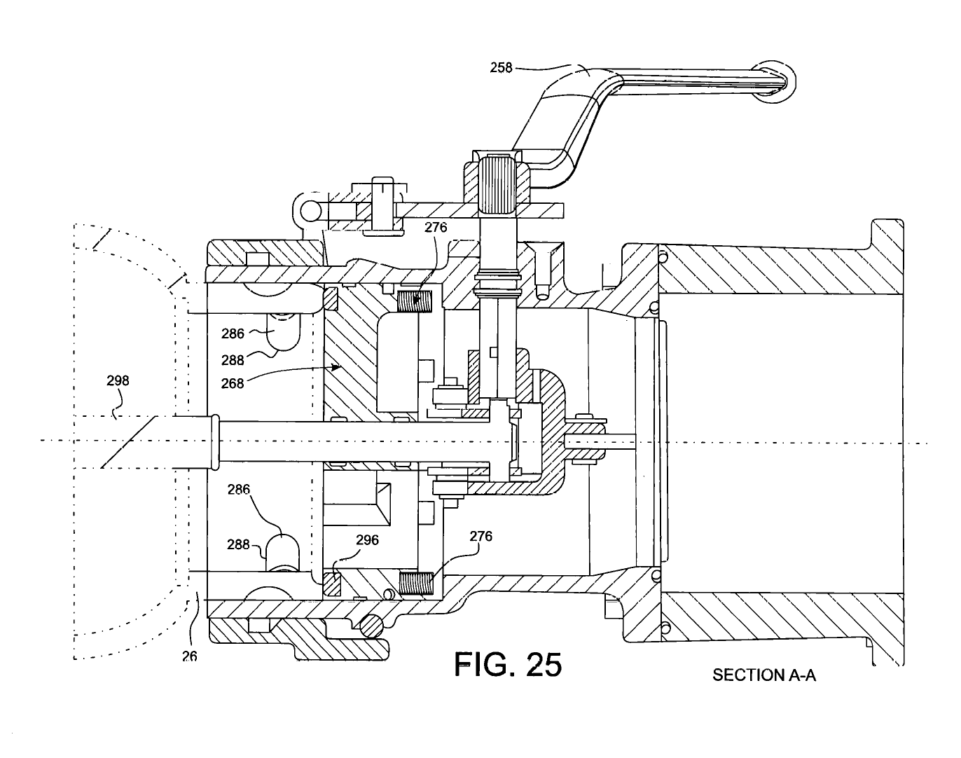

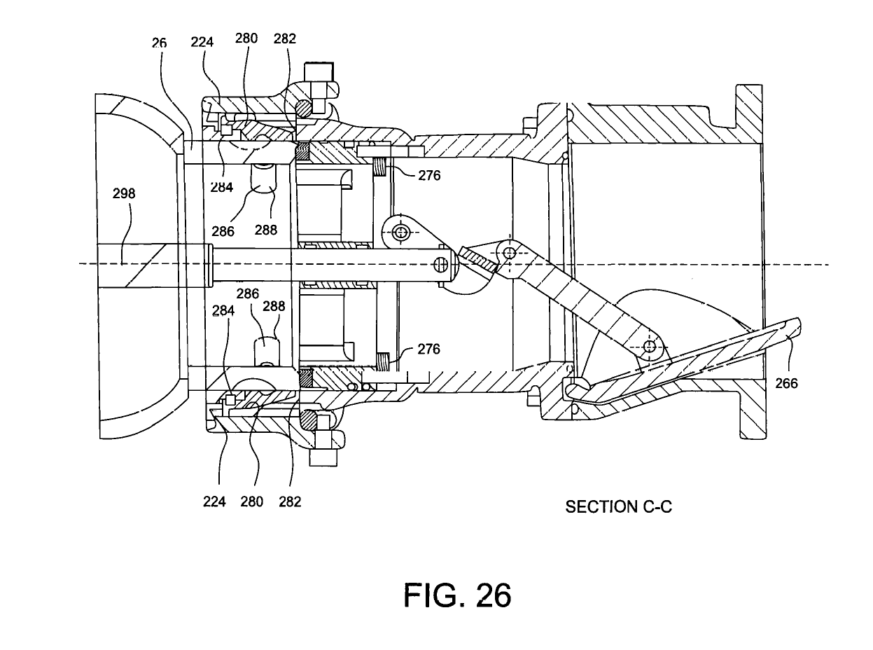

FIGS. 25 and 26 are longitudinal cross-sections, inclined at right angles, of the vapour recovery valve of FIG. 22, shown in a coupled condition;

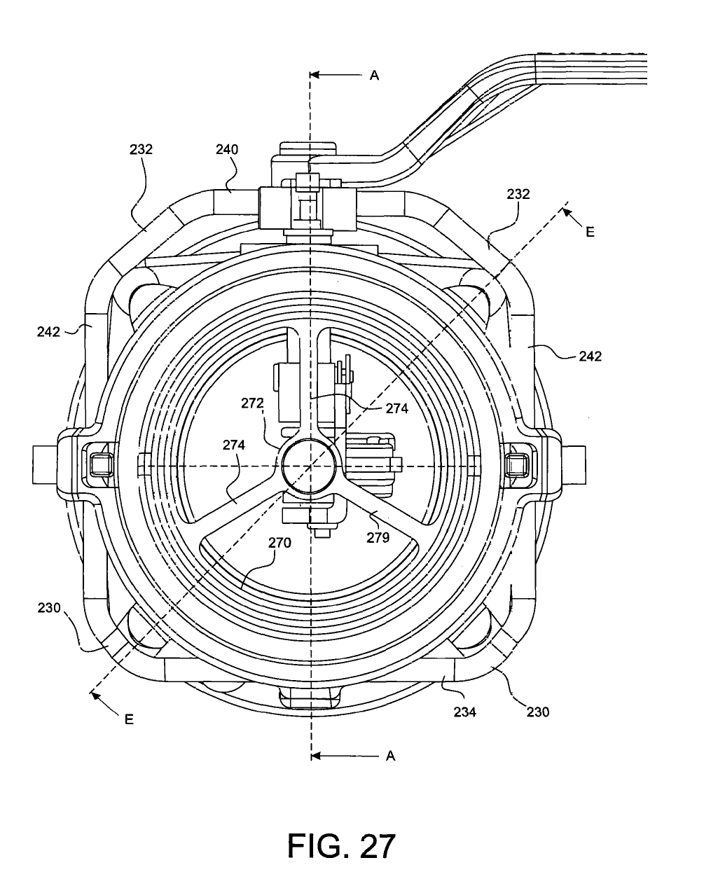

FIG. 27 is a rear view of the vapour recovery valve of FIG. 22, shown in an uncoupled condition;

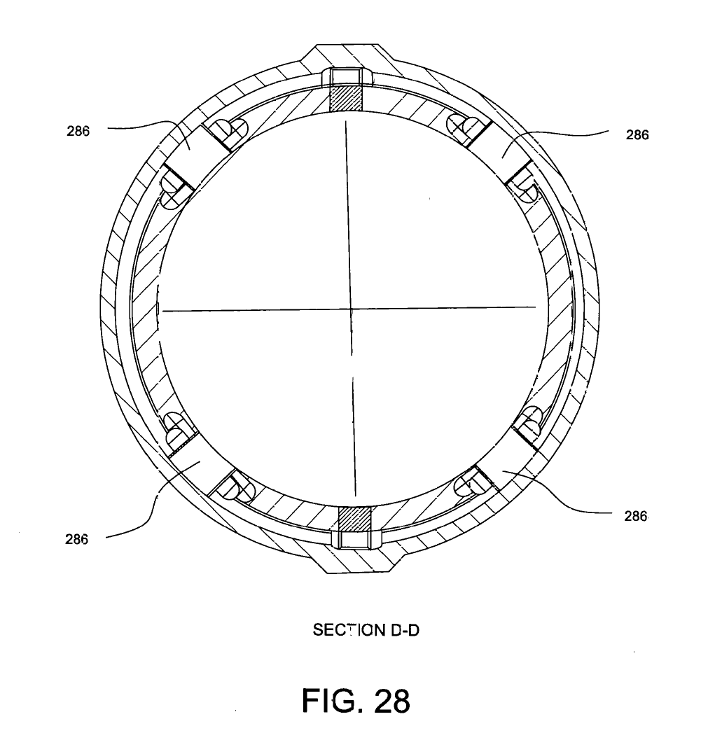

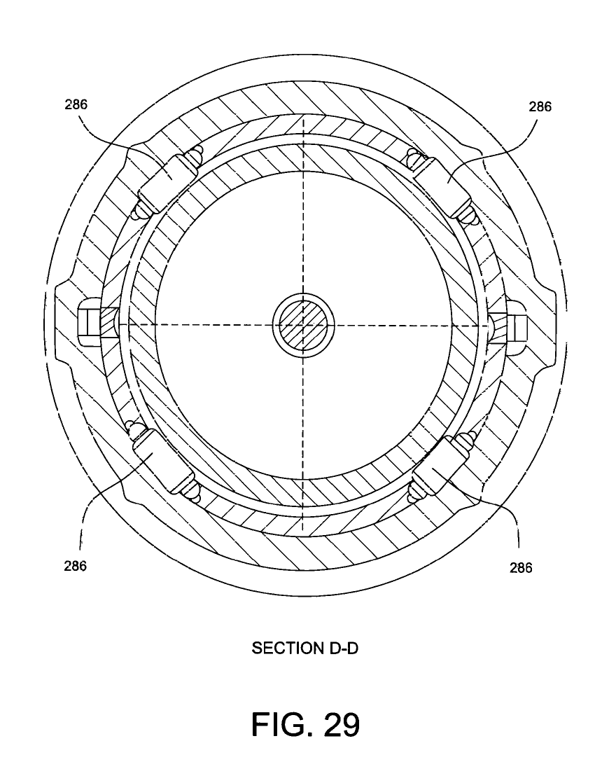

FIGS. 28 and 29 are transverse cross-sections looking in the direction of arrows D-D of FIG. 22, showing the valve in the uncoupled and coupled conditions respectively;

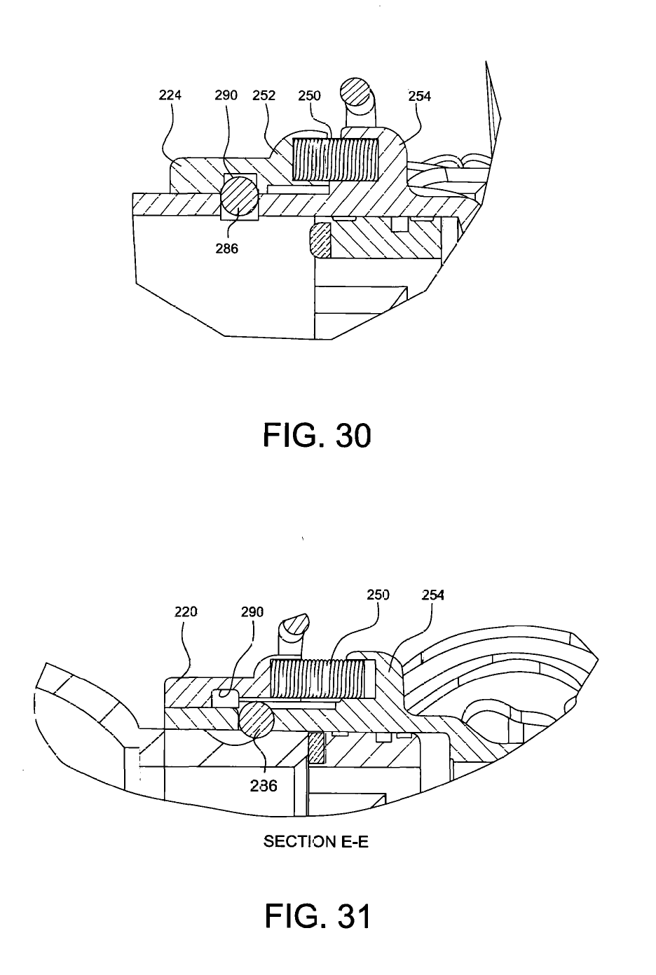

FIG. 30 is a detailed vertical cross-section through a securing collar portion of the vapour recovery valve of FIG. 22, shown in an uncoupled condition;

FIG. 31 is a detailed vertical cross-section through a securing collar portion of the vapour recovery valve of FIG. 22, shown in a coupled condition;

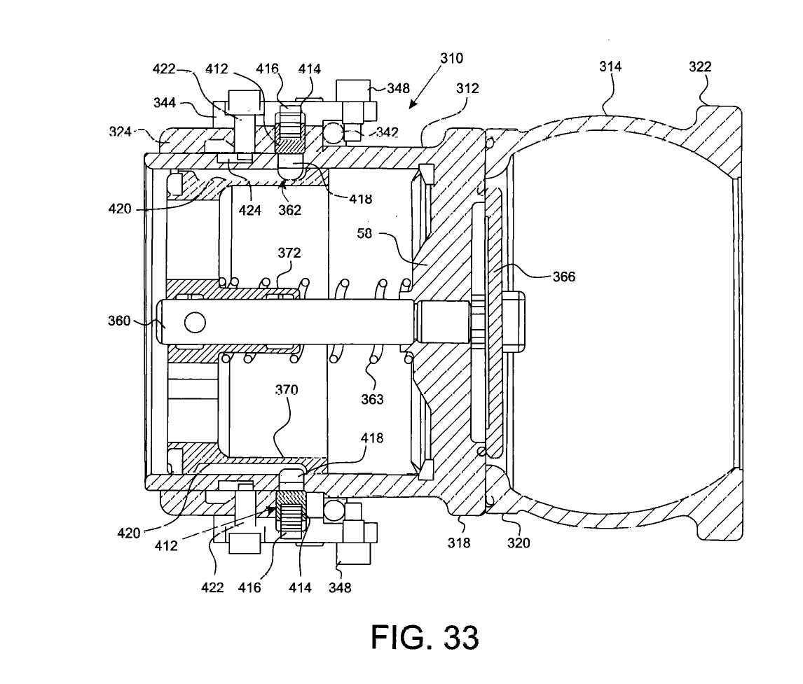

FIGS. 32 and 33 are longitudinal cross-sections, inclined at right angles, of a fifth embodiment of vapour recovery valve in accordance with the present invention, which is a modification of the third embodiment, shown in an uncoupled condition;

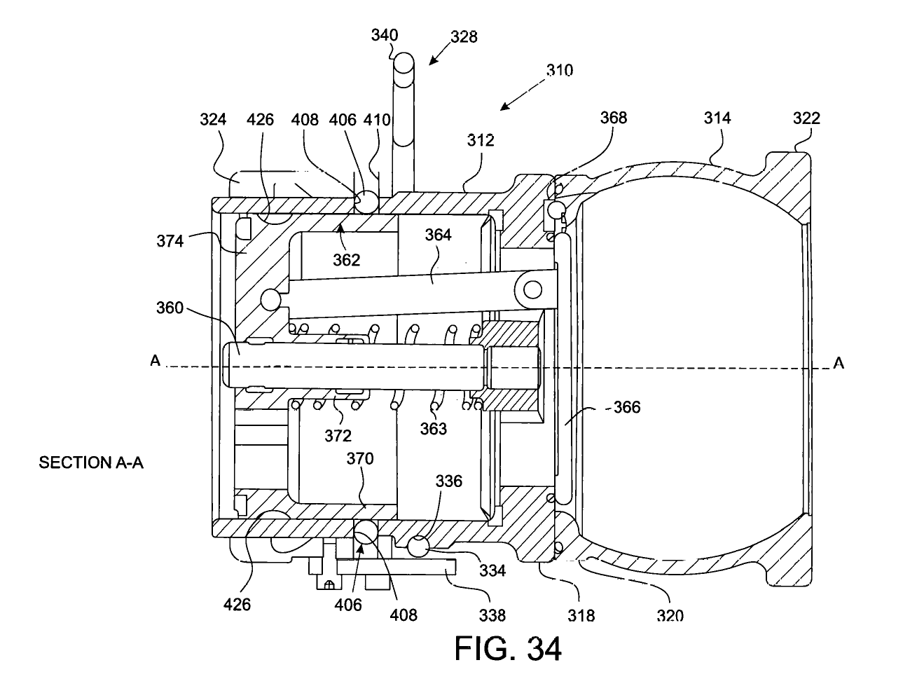

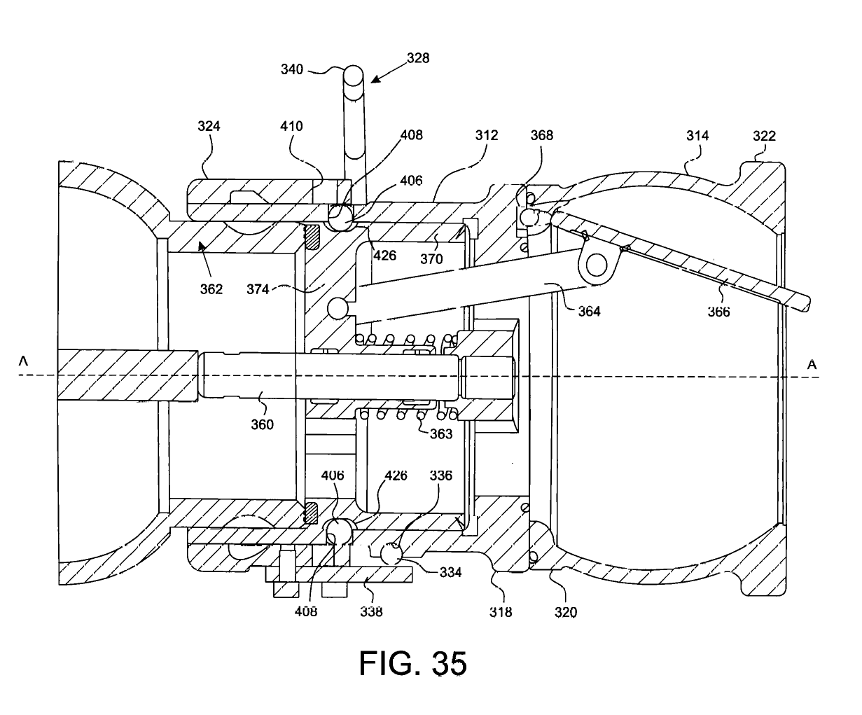

FIGS. 34 and 35 are longitudinal cross-sections, inclined at right angles, of the vapour recovery valve of FIGS. 32 and 33, shown in a coupled condition;

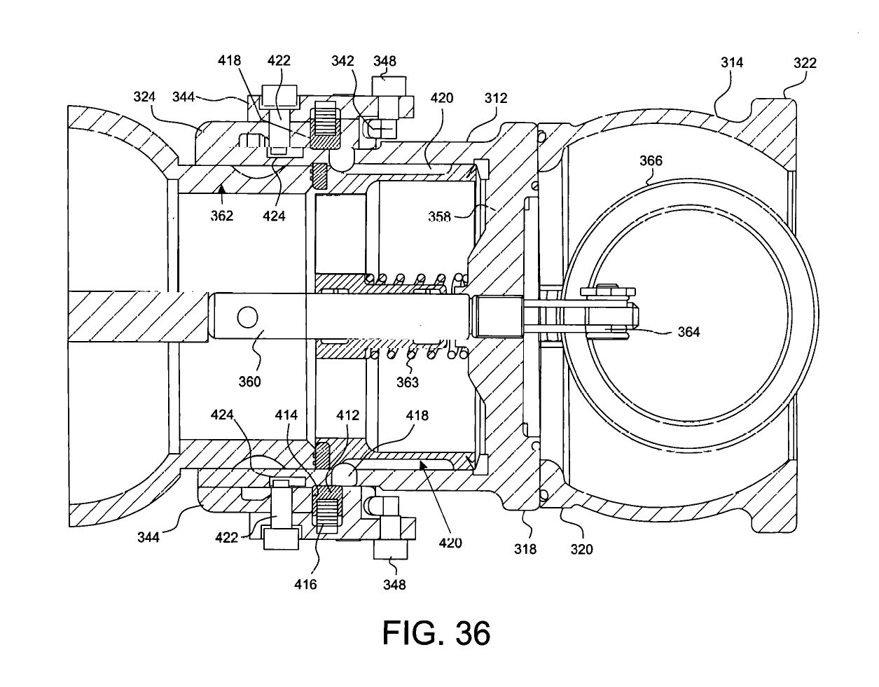

FIG. 36 is a perspective view of an actuating member forming part of the valve of FIGS. 32 and 33; and

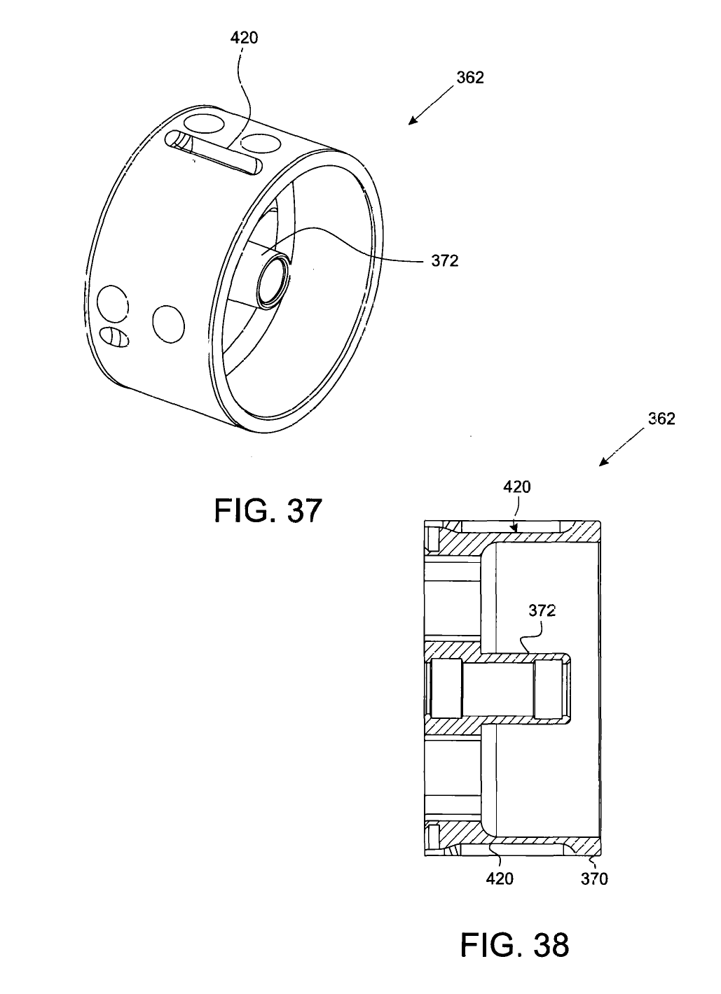

FIG. 37 is a vertical cross-section through the actuating member of FIG. 36.

The first embodiment of vapour recovery valve, shown in FIGS. 1 to 8 of the drawings comprises a cast hollow aluminium valve body 10 having a longitudinal axis A-A. The valve body 10 comprises a generally tubular, cylindrical main portion 12 to which a tubular, generally frusto-conical, longitudinally inner housing portion 14 is secured by means of bolts 16 passing through aligned apertures in abutting securing flanges 18, 20 in the main portion 12 and the inner portion 14. The innermost end of the inner housing portion 14 is also provided with a securing flange 22 having a plurality of apertures for receipt of bolts (not shown) for securing the valve body to a pipe (not shown) leading to a vapour recovery unit. A tubular securing collar 24 is slidably disposed on the outer end of the main body portion 12, for releasable connection of a venting pipe 26 of a fuel tanker (see FIG. 3), as will be explained.

A release handle 28 for the securing collar 24 is also provided. The release handle 28 comprises a rod formed into an annulus of generally rectangular shape having rounded lower corners 30 and upper mitred corners 32. A lower, straight portion 34 of the release handle 28 is pivotally mounted in a complementarily-shaped recess 36 in the outer surface of the main body portion 12 and is held in position by a rearwardly-extending retaining plate 38 forming part of the securing collar 24. An opposite, parallel straight portion 40 is spaced from the opposite side of the main body portion 12 and, in use, forms a portion for actuation by a user.

The opposite, parallel side portions 42 of the release handle 28 pass radially inwardly of two retaining plates 44 located diametrically opposite one another on the outer surface of the securing collar 24 and extending rearwardly. Each of the plates 46 is provided with a bolt 48 passing through the rearward extension of the plate 46 which retains the respective side portions 42 of the release handle 28.

As shown in the figures, the securing collar 24 is biased forwardly (i.e. in the direction from right to left shown in FIG. 1) by means of four compression springs 50 extending between respective recessed pocketed spring mounting lugs 52, 54 on the main housing portion and on the securing collar 24 respectively.

A support brace 58 extends diametrically across the interior of the main body portion 12 at the innermost end of the main body portion, and an elongate cylindrical actuating finger 60 is mounted on the support brace 58 and extends along the longitudinal axis A-A of the valve body, towards the front end (i.e. from right to left as shown in the Figures).

A valve actuating member 62 is slidably and sealingly mounted within the main body portion 12. The valve actuating member 62 is displaceable longitudinally along the main body portion in the direction A-A by engagement with a receiving pipe of a fuel tanker, as will be explained, and is urged in the opposite direction by means of a compression spring 63 extending between the support brace 58 and the rear face of the valve actuating member 62. A connecting link 64 is pivotally mounted to the rear face of the valve actuating member 62 and the opposite end of the connecting link 64 is pivotally mounted to the inner face of a flap valve member 66 which is pivotally mounted in a recess 68 in the innermost face of the main valve body portion 12. The position of the valve actuating member 62 thereby determines the position of the flap valve member 66.

The actuating valve member 62 comprises an outer tubular, cylindrical portion 70 in contact with the inner tubular face of the main body portion 12 and inner tubular cylindrical portion 72 slidably mounted on the actuating finger 60 and three equally angularly spaced arms 74 extending between the inner and outer tubular cylindrical portions 70, 72.

The main body portion 12 carries two locking pins 76 located diametrically opposite one another and spaced 90° from the retaining plates 44. Each locking pin is mounted in a through recess 78 in the main body portion 12, which is aligned with a corresponding recess 80 in the securing collar 24. The securing pins are biased radially inwardly by means of a compression spring 82 acting on an energising pin 84, which are held in position on securing collar 24 by means of a screw-threaded securing cap 86.

When the valve 10 is in the uncoupled position shown in FIGS. 2 and 4, the inner face of each locking pin 76 abuts the outer face of the outer tubular cylindrical portion 70 of the valve actuating member 62, as shown in FIG. 2. In that position, the locking pins 76 project into the corresponding recesses 80 in the securing collar 24 and prevent the securing collar from moving along the main body portion 12.

However, when the valve 10 is in the coupled position shown in FIG. 3, the valve actuating member 62 is displaced inwardly by engagement with the coupling portion 26 of a receiving pipe of a fuel tanker. The coupling portion 26 of the receiving pipe is provided with a peripheral groove 88, into which the locking pins are biased by the compression springs 82. This disengages the locking pins from the corresponding recesses 80 and securing collar and allows the securing collar to be displaced, by means of the four compression springs 50, as will be explained further.

As shown in FIGS. 4 and 5, the outer end of the main valve body 12 is provided with eight identical stainless steel spherical retaining balls 90, each seated in a respective through aperture 92. As will be explained, the balls are releasably engageable with the peripheral groove 88 in the coupling portion 26 of a receiving pipe of a fuel tanker. Each of the balls is also releasably partially receivable in a circumferential recess 94 in the inner face of the securing collar 24, when the valve is in the uncoupled condition, as shown in FIG. 7(b).

When the valve is in the uncoupled condition, shown in FIGS. 2 to 4 and 6, the valve actuating member 62 is biased outwardly by means of the compression spring 63 and the flap valve member 66 is thereby pivoted to its closed position. In the uncoupled position, the inner face of each of the locking pins 76 abuts the outer face of the actuating member 62 and thus the locking pins 76 project into the corresponding recesses 80 in the securing collar 24, thereby preventing movement of the securing collar 24 with respect to the valve 10.

In the uncoupled position, the compression springs 50 extending between the securing collar 24 and the main body portion 12 are compressed. In addition, each of the retaining balls 90 is also in contact with the outer face of the actuating member 62 and is partially received in the corresponding recess 94 in the securing collar 24.

When a fuel tanker is to be loaded with fuel, it is important that fuel vapour within the tanker be properly vented for recovery. The vapour is vented by means of a venting pipe, one end of which is connected to the tanker and the opposite end of which terminates in a valve. In order to vent the tanker, the valve end 26 of the tanker venting pipe is inserted into the valve 10. As the end of the venting pipe 26 is inserted into the cylindrical end of the valve body, it engages with the end face of the valve actuating member 62 and the two are sealed with respect to one another by means of an annular seal 96 secured in the outer face of the valve actuating member 62. As the end of the venting pipe 26 is pushed into the valve 10, the valve actuating member 62 is displaced (to the right as shown in the figures). This causes the flap valve member 66 to open, into the position shown in FIG. 3. At the same time, the outermost end of the actuating finger 60 engages with a valve actuating member 98 of the tanker venting pipe which causes a valve (not shown) within the tanker venting pipe to open.

As the valve actuating member 62 is displaced by insertion of the tanker venting pipe 26, the locking pins 76 are no longer in abutment with the valve actuating member. This allows the locking pins 76 two be displaced inwardly, by means of the compression spring 82 and energising pin 84 mounted on the securing collar 24, into the peripheral groove 88 of the tanker venting pipe 26. The securing collar 26 is therefore no longer locked with respect to the main body portion 12, and as a consequence the securing collar 24 is displaced to the position shown in FIG. 3 by means of the compression springs 50 extending between the securing collar and the main body portion 12. This movement of the securing collar 24 disengages the balls 90 from the recesses 94 in the securing collar and causes them to move radially inwardly, into the peripheral recess 88, thereby securing the tanker venting pipe 26 to the valve 10.

When it is desired to disengage the tanker venting pipe 26 and the valve 10, the release handle 28 is pulled rearwardly. This in turn causes the securing collar 24 to be displaced rearwardly, against the restoring force of the springs 50. This allows the balls 90 to be received in the corresponding recess 94 in the inner face of the securing collar 24, thereby unlocking the tanker venting pipe 26 and the valve 10. The locking pins 76 are also once again aligned with the corresponding recesses 80 in securing collar. As the venting pipe 26 is withdrawn, the valve actuating member 62 is displaced to the left by virtue of the restoring force of spring 63 and eventually the locking pins 76 engage the outer face of the valve actuating member 62 and are aligned with the corresponding recesses 80 in the securing collar 24, thereby preventing movement of the locking collar 24 respect the valve 10.

The second embodiment, illustrated in FIGS. 9 to 12 is very similar to the first embodiment and corresponding features have been given the same reference numerals.

The only significant difference between the first and second embodiments is that the eight spherical stainless steel balls 90 of the first embodiment have been replaced with four identical rollers 100, equally angularly spaced around the periphery of the main body portion 12.

The rollers 100 are profiled to have a concave, waisted shape to correspond with the shape of the tanker venting pipe to be received in the valve 100. As a consequence, the shape of the corresponding recesses 102 in the inner face of the securing collar 24 is adjusted accordingly. The use of rollers instead of balls spreads the area over which engagement takes place, and reduces wear on the tanker venting pipe 26 when inserted into the valve.

The third embodiment, illustrated in FIGS. 13 to 21, is similar to the second embodiment, but the mechanism by which the securing collar is locked to the valve body until the venting pipe is inserted into the valve body is different. In the following description, features corresponding to those of the second embodiment are identified with the same reference numeral, with the addition of a prime (′).

The vapour recovery valve shown in the drawings comprises a cast hollow aluminium valve body 10′ having a longitudinal axis A-A. The valve body 10′ comprises a generally tubular, cylindrical main portion 12′ to which a tubular, generally frusto-conical, longitudinally inner housing portion 14′ is secured by means of bolts 16′ passing through aligned apertures in abutting securing flanges 18′, 20′ in the main portion 12′ and the inner portion 14′. The innermost end of the inner housing portion 14′ is also provided with a securing flange 22′ having a plurality of apertures for receipt of bolts (not shown) for securing the valve body to a pipe (not shown) leading to a vapour recovery unit. A tubular securing collar 24′ is slidably disposed on the outer end of the main body portion 12′, for releasable connection of a venting pipe 26′ of a fuel tanker (see FIG. 3), as will be explained.

A release handle 28′ for the securing collar 24′ is also provided. The release handle 28′ comprises a rod formed into an annulus of generally rectangular shape having rounded lower corners 30′ and upper mitred corners 32′. A lower, straight portion 34′ of the release handle 28′ is pivotally mounted in a complementarily-shaped recess 36′ in the outer surface of the main body portion 12′ and is held in position by a rearwardly-extending retaining plate 38 forming part of the securing collar 24′. An opposite, parallel straight portion 40′ is spaced from the opposite side of the main body portion 12′ and, in use, forms a portion for actuation by a user.

The opposite, parallel side portions 42′ of the release handle 28′ pass radially inwardly of two retaining plates 44′ located diametrically opposite one another on the outer surface of the securing collar 24′ and extending rearwardly. Each of the plates 46′ is provided with a bolt 48′ passing through the rearward extension of the plate 46′ which retains the respective side portions 42′ of the release handle 28′.

As shown in the figures, the securing collar 24′ is biased forwardly (i.e. in the direction from right to left shown in FIG. 1) by means of four compression springs 50′ extending between respective recessed pocketed spring mounting lugs 52′, 54′ on the main housing portion and on the securing collar 24′ respectively.

A support brace 58′ extends diametrically across the interior of the main body portion 12′ at the innermost end of the main body portion, and an elongate cylindrical actuating finger 60′ is mounted on the support brace 58′ and extends along the longitudinal axis A-A of the valve body, towards the front end (i.e. from right to left as shown in the Figures).

A valve actuating member 62′ is slidably and sealingly mounted within the main body portion 12′. The valve actuating member 62′ is displaceable longitudinally along the main body portion in the direction A-A by engagement with a receiving pipe of a fuel tanker, as will be explained, and is urged in that direction by means of a compression spring 63′ extending between the support brace 58′ and the rear face of the valve actuating member 62′. A connecting link 64′ is pivotally mounted to the rear face of the valve actuating member 62′ and the opposite end of the connecting link 64′ is pivotally mounted to the inner face of a flap valve member 66′ which is pivotally mounted in a recess 68′ in the innermost face of the main valve body portion 12′. The position of the valve actuating member 62′ thereby determines the position of the flap valve member 66′.

The actuating valve member 62′ comprises an outer tubular, cylindrical portion 70′ in contact with the inner tubular face of the main body portion 12′ and an inner tubular cylindrical portion 72′ slidably mounted on the actuating finger 60′ and three equally angularly spaced arms 74′ extending between the inner and outer tubular cylindrical portions 70′, 72′.

The description of the above features is virtually identical to the description of the corresponding features of the second embodiment.

As shown in the Figures, the length (in the longitudinal direction) of the securing collar 24′ is longer than that of the securing collar second embodiment. In addition, the locking pins 76 and the associated recess 80, spring 82, energising pins 84 and securing caps 86 of the second embodiment are omitted.

As shown in FIGS. 13 to 21, the main valve body portion 12′ is provided with four spherical stainless steel balls 106, each located in a respective through aperture 108, equally angularly spaced around the periphery of the valve body portion 12′. Each of the balls 106 is seated in a respective ball lock groove 110 extending longitudinally in the outer face of the valve actuating member 62′, each groove terminating at its longitudinal outer end in an enlarged recess 114 for receipt of a locking ball 106.

When the valve is in the uncoupled condition shown in FIGS. 14, 16, 17, 18 and 20, each of the balls 106 is partially received in a respective recess 112 on the inner face of the securing collar 24′, located toward the inner end of the collar. In this condition, the engagement of the balls 106 in the recess 112 prevents movement of the securing collar 24′ with respect to the valve body 12′. However, the provision of the ball lock grooves 110 allows a certain amount of displacement of the valve actuating member 62′ whilst maintaining engagement of the balls 106 in the recesses 112.

The valve is used in the same way as the first and second embodiments. As the venting pipe 26 is inserted into the valve, it sealingly engages the end face of the valve actuating member 62′ and further inward movement of the venting pipe causes inward displacement of the valve actuating member and consequent opening of the flap valve 66′. The valve actuating member 62′ is able to slide past the locking balls 106 by means of the ball lock grooves 110 and as the valve actuating member 62′ is displaced inwardly to its maximum extent, the locking balls 106 are received in the enlarged recesses 114 at the outer end of the ball lock grooves 110, which disengages the locking balls 106 from the corresponding recesses 112 in the inner face of the securing collar 24′, thereby unlocking the securing collar 24′ from the main valve portion 12′. As a consequence, the locking collar 24′ is displaced outwardly (towards the left are shown in the Figures) by virtue of the compression springs 50′. In this position, the rollers 100′ engage with the peripheral recess 88′ in the venting pipe 26′, as in the second embodiment, thereby releasably securing the venting pipe 26′ to the valve 10′.

In order to uncouple the venting pipe 26′ from the valve 10′, the release handle 28′ is pulled as in the second embodiment. Pulling the release handle 28′ withdraws the securing collar 24′, which allows the rollers 100′ to disengage from the peripheral recess 88 in the venting pipe 26, thereby allowing the venting pipe to be withdrawn. Withdrawing the securing collar 24′ also results in the locking balls 106 being received in the corresponding recesses 112 in the inner face of the securing collar. This in turn allows the valve actuating member 62′ to be displaced outwardly, by virtue of the restoring force of spring 63′, which is permitted by virtue of the ball lock grooves 110. Receipt of the locking balls 106 in the corresponding recesses 112 also serves to lock the position of the securing collar 24′ with respect to the valve 10′.

The construction and operation of the third embodiment are otherwise identical to that of the second embodiment.

The fourth embodiment of the present invention is illustrated in FIGS. 22 to 31 and comprises a cast hollow aluminium valve body 210 having a longitudinal axis A-A. The valve body 210 comprises a generally tubular, cylindrical main portion 212 to which a tubular, generally cylindrical inner housing portion 214 is secured by means of bolts 216 passing through aligned apertures in abutting securing flanges 218, 220 in the main portion 212 and the inner portion 214. The innermost end of the inner housing portion 214 is also provided with a securing flange 222 having a plurality of apertures for receipt of bolts (not shown) for securing the valve body to a pipe (not shown) leading to a vapour recovery unit. A tubular securing collar 224 is slidably disposed on the outer end of the main body portion 212, for releasable connection of a venting pipe to 26 of a fuel tanker, as will be explained.

A release handle 228 for the securing collar 224 is also provided. The release handle 228 comprises a rod formed into an annulus of generally rectangular shape having rounded lower corners 230 and upper mitred corners 232. A lower, straight portion 234 of the release handle 228 is pivotally mounted in a complementarily-shaped recess 236 in the outer surface of the main body portion 212 and is held in position by a rearwardly extending projection 238 of the securing collar 224. The opposite, parallel straight portion 240 is spaced from the opposite side of the main body portion. A collar 239 is pivotally mounted on the parallel, straight portion and the collar has a pin 237 which is received in a cam track 243 of a cam plate 241 secured to a valve actuating handle 258, to be described in more detail hereafter.

The opposite, parallel side portions 242 of the release handle 228 pass radially inwardly of two retaining plates 244 located diametrically opposite one another on the outer surface of the securing collar 224 and extending rearwardly. Each of the plates is provided with a bolt 248 passing through the rearward extension of the plate 246, and holding the respective side portions 242 of the release handle 228. The Securing collar 224 is biased forwardly (i.e. in the direction from right to left shown in FIG. 1) by means of four compression springs 250 extending between respective recessed pocket spring mounting lugs 252, 254 on the main housing portion among the securing collar 224 respectively.

A flap valve member 266 is pivotally mounted in a recess 268 in the innermost face of the main valve body portion 212. The flap valve member 266 is actuated by rotating actuating handle 258 which is mounted on a shaft 260. The shaft 260 is sealingly and rotatably mounted in an aperture 262 extending laterally through the wall of the main body portion 212. The inner end of the shaft 260 is connected to an actuating linkage 264 which is in turn pivotally connected to the connecting link 267, the other end of the connecting link 267 being pivotally connected to the rear face of the flap valve 266. Adjustment of the position of the handle 258 therefore determines the position of the flap valve 266.

The linkage 264 is also pivotally connected to an elongate cylindrical actuating finger 269 which passes slidably through the centre of an actuating body 268, as will be explained.

Rotation of the handle 258 also causes displacement of the actuating finger 269 outwardly, to the left as shown in the figures. As shown in the figures, the actuating body 268 is slidably and sealingly mounted within the main body portion 212. The valve actuating member 268 is displaceable longitudinally along the main body portion in the direction A-A into engagement with a receiving pipe 26 of a fuel tanker, as will be explained. The actuating member comprises an outer tubular cylindrical portion 270 in contact with the inner tubular face of the main body portion 212 and an inner tubular cylindrical portion 272 through which the actuating finger 269 slidably extends, and three equally angularly spaced arms 274 extending between the inner and outer tubular cylindrical portions 270, 272.

The actuating member is displaceable a short distance within the main body portion 12. It is biased outwardly (from right to left as shown in the Figures) by means of four compression springs 276 extending between the rear face of the outer tubular cylindrical portion 270 and an annular shoulder of the main body portion 212. In the uncoupled position, the maximum displacement of the actuating member is limited by a boss 278 on the outermost end of the finger 269 which passes through the inner tubular cylindrical portion 272.

Main body portion 212 carries two latches 280 which are pivotally mounted in through recesses 282 in the body, diametrically opposed to each other. The latches are biased by means of springs 284 to a position in which the inner end projects beyond the inner face of the main body portion 212 and the outer end engages with a corresponding recess in the outer end face of the securing collar 224. In the uncoupled position, therefore, engagement of the latches with the securing collar 224 prevents longitudinal movement of the securing collar 224 with respect to the main body portion 212. However, upon insertion of the coupling portion 26 of a receiving pipe of a fuel tank, the receiving pipe engages the inwardly projecting ends of the latches and pivots them out of engagement with the securing collar 224, thereby allowing the collar to be displaced longitudinally, subject to the position of the handle 258.

In a similar manner to the second embodiment, the main body portion 212 is also provided with four identical rollers 286, equally angularly spaced around the periphery of the main body portion. Each of the rollers 286 is seated in a respective through aperture 288 and is profiled to have a concave, waisted shape to correspond with the shape of a tanker venting pipe to be received in the valve. As will be explained, the rollers 286 are releasably engageable with the peripheral groove 88 in the coupling portion 26 of a receiving pipe of a fuel tanker. Each of the rollers is also releasably partially receivable in a peripheral recess 290 in the inner face of the securing collar 224, when the valve is in the uncoupled condition.

When the valve is in the uncoupled condition, the valve actuator is biased outwardly (to the left as shown in figures) by means of the compression springs 276 to the extent permitted by engagement with the boss 278 on the end of the actuating finger 269. In this condition, the handle 258 is pivoted so that the flap valve 226 is in the closed position, which causes the actuating collar 224 to be displaced into its withdrawn position, in which the latches 280 engage the longitudinally outermost ends of the collar 224. In this condition, it is not possible to rotate the handle 258, since this is prevented by the fact that the actuating collar 224 is locked to the main housing portion 212 by virtue of the latches.

When a fuel tanker is to be loaded with fuel, in order to vent the tanker, the valve end 26 of the tanker venting pipe is inserted into the valve 210. As the end of the venting pipe 26 is inserted into the cylindrical end of the valve body, it engages with the end face of the valve actuating member 268 and the two are sealed with respect to one another by means of an annular seal 296 secured to the outer face of the valve actuating member. Insertion of the venting pipe also causes the latches 280 to pivot, thereby disengaging them from the actuating collar 224.

As the valve actuating member is displaced by insertion of the tanker venting pipe 26, against the restoring force of the compression springs, the handle 258 can then be rotated, since the actuating collar 224 is no longer locked to the main body portion 212. Rotation of the handle 258 also rotates the cam plate 241, which in turn causes displacement of the locking collar 224 outwardly, by virtue of engagement of the pin 237 of the collar 239 in the cam track 243.

As a result of the displacement of the actuating collar 224, the rollers 286 are displaced out of the corresponding recess 290 in the inner face of the actuating collar 224 and are urged into the peripheral recess 88 in the tanker venting pipe 26, thereby securing the tanker venting pipe to the valve 210.

Rotation of the handle 258 also causes the flap valve 266 to open and additionally displaces the finger 269 outwardly, for engagement with a valve actuating member 298 of the tanker venting pipe which causes the valve (not shown) within the tanker venting pipe to open.

When it is desired to disengage tanker venting pipe 26 and the valve 210, the handle 258 is pivoted in the opposite direction. This causes the securing collar 224 to be displaced rearwardly, against the restoring force of the springs 250. This allows the rollers 286 to be received in the corresponding recess in the inner face of securing collar 224, thereby unlocking the tanker venting pipe 26 and the valve 210. Rotation of the handle 258 also shuts the flap valve 266 and withdraws the actuating finger 269, thereby causing closing of the valve within the tanker venting pipe.

The tanker venting pipe 26 can then be withdrawn from the valve 210. Upon withdrawal of the tanker venting pipe, the latches 280 are allowed to pivot back to the rest position under the influence of the restoring force of the springs 284, thereby engaging the outer ends of the latches with the outer face of the securing collar 224 and locking the securing collar 224 in position.

The fifth embodiment of the invention is illustrated in FIGS. 32 to 37. The vapour recovery valve of the fifth embodiment is similar to that of the third embodiment and corresponding features are identified by the same reference numerals, but commencing with “3”. The valve comprises a cast hollow aluminium valve body 310 having a longitudinal axis A-A. The valve body 310 comprises a generally tubular, cylindrical main portion 312 to which a longitudinally inner housing portion 314 is secured by means of bolts 316 passing through aligned apertures in abutting securing flanges 318, 320 in the main portion 312 and the inner portion 314.

As shown in the figures, the longitudinally inner housing portion 314 has a bulbous shape and, as seen in FIGS. 34 and 35, receives a valve closure member 366 of the valve when the valve is in the open condition. The innermost end of the housing portion 314 is also provided with a securing flange 322 having a plurality of apertures for the receipt of bolts (not shown) for securing the valve body to a pipe (not shown) leading to a vapour recovery unit. A tubular securing collar 324 is slidably disposed on the outer end of the main body portion 312, for releasable connection of a venting pipe 326 of a fuel tanker (see FIGS. 34 and 35). A release handle 328 for the securing collar 324 is also provided. The release handle 328 comprises a rod formed into an annulus of generally rectangular shape having rounded lower corners 230 and upper mitred corners 332. A lower, straight portion 334 of the release handle 328 is pivotally mounted in a complementarily-shaped recess 336 in the outer surface of the main body portion 312 and is held in position by a rearwardly-extending retaining plate 338 forming part of the securing collar 324. An opposite, parallel straight portion 340 is spaced from the opposite side of the main body portion 312 and, in use, forms a portion for actuation by a user.

The opposite, parallel side portions 342 of the release handle 328 pass radially inwardly of two retaining plates 344 located diametrically opposite one another on the outer surface of the securing collar 324 and extending rearwardly. Each of the plates 344 is provided with a bolt 348 passing through the rearward extension of the plate 346 which retains the respective side portions 342 of the release handle 328.

The securing collar 324 is biased forwardly (i.e. in the direction from right to left) by means of four compression springs 350 extending between respective recessed pocketed spring mounting lugs 352, 354 on the main housing portion 312 and on securing collar 324 respectively.

A support brace 358 extends diametrically across the interior of the main body portion 312 at the innermost end of the main body portion, and a cylindrical actuating finger 360 is mounted on the support brace 358 and extends along the longitudinal axis A-A of the valve body, towards the front end (i.e. from right to left as shown in the figures).

A valve actuating member 362 is slidably and sealingly mounted within the main body portion 312. The valve actuating member 262 is displaceable longitudinally along the main body portion in the direction A-A by engagement with a receiving pipe 326 of a fuel tanker, as will be explained, and is urged in that direction by means of a compression spring 363 extending between support brace 358 and the rear face of the valve actuating member 362.

A connecting link 364 is pivotally mounted to the rear face of the valve actuating member 362 and the opposite end of the connecting link 364 is pivotally mounted to the inner face of a flap valve member 366 which is pivotally mounted in a recess 368 in the innermost face of the main valve body portion 312. The position of the valve actuating member 362 thereby determines the position of the flap valve member 366.

The actuating valve member 362 comprises an outer tubular, cylindrical portion 370 in contact with the inner tubular face of the main body portion 312 and an inner tubular cylindrical portion 372 slidably mounted on the actuating finger 360 and three equally angularly spaced arms 374 extending between the inner and outer tubular cylindrical portions hundred 70, 372.

The description of the above features is very similar to the description of the corresponding features of the third embodiment.

As shown in FIGS. 32 to 37 the main valve body portion is provided with four spherical stainless steel balls 406, each located in a respective through aperture 408, equally angularly spaced around the periphery of the valve body portion 312. Each of the balls 406 is receivable in an associated through aperture 410 in the securing collar 324 and is sized so that it can be partially received within the through aperture 410 such that it does not project into the interior of the valve body portion 312, but is prevented from passing radially outwardly through the aperture 410.

As best seen in FIGS. 32 and 35, the securing collar 324 carries two identical, diametrically opposed cylindrical pins 412 which are slidably disposed in corresponding through apertures 414 passing through the securing collar 324. The pins 412 or biased radially inwardly by a respective compression spring 416 whose outer end is received in a respective recess formed in the retaining plates 344.

The inner end of each of the pins 412 bears upon the inner flat face of a respective pin 418 having a radially outer cylindrical wall portion and a radially inner hemispherical head. Each of the pins 418 is received in a respective cam groove 420 in the outer face of the actuating valve member 362, as will be explained.

It will also be seen from FIGS. 33 and 35 that two diametrically opposed bolts 422 pass radially through the retaining plates 344 and the securing collar 324, the radially inner ends of the bolts being received in a peripheral groove 424 in the outer face of the main body portion 312, in order to limit the movement of the securing collar 324 with respect to the valve housing.

When the valve is in the uncoupled condition shown in FIGS. 32 and 33, stainless steel balls 406 are in engagement with the outer face of the actuating valve member 362 and partially received in the apertures 408 in the securing collar 324. In addition, the inner end of each of the hemispherical headed pins 418 is located at the inner end of its cam groove 420 and as a result the cylindrical pins project partially into the corresponding aperture in the main body portion 314.

Consequently, the actuating valve member 362 is free to move with respect to the main body portion 314 but the securing collar 324 is locked to the main body portion 340.

In use, as a venting pipe 326 is inserted into the valve, it sealingly engages the end face of the valve actuating member 362 and further inward movement of the venting pipe causes inward displacement of the valve actuating member and consequent opening of the flap valve 366. The valve actuating member 362 is able to slide past the hemispherical headed pins 418 as the pins are slidably disposed in their respective cam grooves 420. As the valve actuating member 362 is displaced inwardly to its maximum extent, the stainless steel balls 406 move radially inwardly into a respective recess 426 located on the outer surface of the valve actuating member towards its outer end. The securing collar 324 is thereby unlocked from the main body portion 314 and is displaceable relative thereto and at the same time the balls 406 lock the valve actuating member 362 in position with respect to the main body portion 314.

At the same time that the stainless steel balls 406 are received into the respective recesses 426, the hemispherical headed pins 418 reach the outer end of the cam groove, the cam grooves 420 being shaped at the outer end to displace the pins 418 radially outwardly so that the pins 418 displace the pins 414 completely out of the associated through recess in the main body portion 314, which further unlocks the securing collar 324 with respect to the main body portion 314.

Since the securing collar 324 and the main body portion 314 are unlocked, the force of the compression springs 350 displaces the securing collar 324 outwardly to its maximum extent (as governed by the bolts 422 engaging in their respective grooves 424), thereby preventing disengagement of the stainless steel balls 406 from the valve actuating member 362.

In order to uncouple the venting pipe 326 from the valve 310, the release handle 328 is pulled as in the second and third embodiments. Pulling the release handle 328 withdraws the securing collar 324, which allows the stainless steel balls 406 to be displaced radially outwardly out of engagement with the valve actuating member 362 and into the associated apertures 408 in the securing collar 324. This in turn allows the valve actuating member 362 to be displaced outwardly, by virtue of the restoring force of spring 363, which is permitted by virtue of the engagement of the hemispherical headed pins 418 in the longitudinal grooves 420. As the pins 418 slide along the grooves 420, they are able to move radially inwardly and eventually displace the pins 414 so that they re-engage in the associated apertures in the main body portion 314, thereby locking the securing collar 324 with respect to the main body portion 312.

The invention is not restricted to the details of the foregoing embodiments.

1. A valve for a vapour recovery system, comprising:
a valve body having an inlet and an outlet,
a valve seat located within the valve body,
a valve closure member releasably engageable with the valve seat,
a socket portion configured to receive a pipe member to be coupled,
a plurality of first engagement members configured to be releasably engageable with a portion of the pipe member received in the socket portion, the plurality of first engagement members releasably retaining the pipe member in the socket portion, and
an actuation member mounted on the valve body, the actuation member comprising a recess configured to receive each of the plurality of first engagement members, the actuation member being displaceable between a first position in which the each of the plurality of first engagement members are received in the recess in the actuation member and a second position in which the actuation member urges the each of the plurality of first engagement members inwardly toward a deployed configuration in which the each of the plurality of first engagement members engages with and retains the pipe member received by the socket portion.

2. The valve as claimed in claim 1, wherein the each of the plurality of first engagement members is mounted on the valve body.

3. The valve as claimed in claim 2, wherein the each of the plurality of first engagement members is mounted in a recess in the valve body.

4. The valve as claimed in claim 3, wherein the each of the plurality of first engagement members is mounted in a through recess in the valve body.

5. The valve as claimed in claim 1, wherein the each of the plurality of first engagement members comprises balls.

6. The valve as claimed in claim 1, wherein the each of the plurality of first engagement members comprises rollers.

7. The valve as claimed in claim 1, further comprising means for biasing the actuation member toward the second position.

8. The valve as claimed in claim 1, further comprising spring means for biasing the actuation member toward the second position.

9. The valve as claimed in claim 1, further comprising locking means for preventing movement of the actuation member from the first position to the second position until a pipe member is engaged in the socket portion.

10. The valve as claimed in claim 9, further comprising a locking member mounted in a through recess in the valve body and being configured to be receivable in a recess in the actuation member, the locking member being further configured to be displaceable between a locking position in which the locking member is received in the recess in the actuation member and an unlocked position in which the locking member is displaced out of the recess in the actuation member.

11. The valve as claimed in claim 10, further comprising spring means for biasing the locking member toward the unlocked position.

12. The valve as claimed in claim 10, further comprising a second engagement member slidably disposed within the valve body, the second engagement member being configured to be displaceable by engagement of the pipe member in the socket portion between a first position in which the second engagement member abuts the locking member and retains the locking member in the locking position and a second position in which the second engagement member is displaced out of engagement with the locking member.

13. The valve as claimed in claim 10, wherein the locking member is displaced radially inwardly in the unlocked position.

14. The valve as claimed in claim 13, wherein the locking member is displaced radially inwardly into a recess in the pipe member engaged in the socket portion.

15. The valve as claimed in claim 13, wherein the second engagement member comprises an elongate recess in which the locking member is located and which allows movement of the second engagement member with the locking member in the locking position, the elongate recess having an enlarged portion that is configured to receive the locking member, to permit the locking member to be displaced to the unlocked position.

16. The valve as claimed in claim 15, wherein the enlarged portion is located at one end of the elongate recess.

17. The valve as claimed in claim 12, wherein:
the second engagement member is connected to the valve closure member, and
a position of the second engagement member determines a position of the valve closure member.

18. The valve as claimed in claim 15, further comprising a connecting link extending between the second engagement member and the valve closure member.

19. The valve as claimed in claim 9, wherein the locking means comprises latch means mounted on the valve body, the latch means being configured to be displaceable between a latched position in which the latch means retains the actuation member in the first position and an unlatched position in which the latch means is disengaged from the actuation member.

20. The valve as claimed in claim 19, wherein the latch means are mounted in the socket portion and configured to be displaced to the unlatched position on receipt of a pipe member in the socket portion.

21. The valve as claimed in claim 1, further comprising release means for disengaging the plurality of first engagement members from the pipe member located in the socket portion.

22. The valve as claimed in claim 21, wherein the release means comprises a release handle for displacing the actuation member from the second position toward the first position.

23. The valve as claimed in claim 22, wherein the release handle is pivotally mounted with respect to the valve body.

24. The valve as claimed in claim 22, wherein the release handle is displaceable manually.

25. The valve as claimed in claim 22, wherein:
the valve closure member is operable manually by displacement of a valve actuating handle, and
a position of the valve actuating handle determines a position of the release handle.

26. The valve as claimed in claim 25, further comprising cam means movable with the valve actuating handle and connected to the release handle.
